(19) United States
(12) Patent Application Publication
(10) Pub. No.: US 2025/0070563 A1
(43) Pub. Date: Feb. 27, 2025

(54) SYSTEM AND METHOD FOR A MULTI-AGENT CONSENSUS BASED-VIRTUAL INERTIA CONTROLLER FOR LOW INERTIAL MICROGRIDS

(71) Applicant: KING FAHD UNIVERSITY OF PETROLEUM AND MINERALS, Dhahran (SA)

(72) Inventors: Ibrahim Mohammad K. ALOTAIBI, Dhahran (SA); Mohamed Ali ABIDO, Dhahran (SA)

(73) Assignee: KING FAHD UNIVERSITY OF PETROLEUM AND MINERALS, Dhahran (SA)

(21) Appl. No.: 18/454,914

(22) Filed: Aug. 24, 2023

(51) Int. Cl. H02J 3/38; H02J 3/18; H02J 3/32; H02J 7/00

(52) U.S. Cl. CPC H02J 3/381; H02J 3/18; H02J 3/32; H02J 7/0016; H02J 2203/10; H02J 2203/20; H02J 2300/24; H02J 2300/28

(57) ABSTRACT

A control system to regulate frequency of an islanded microgrid that includes at least one grid-tied renewable energy source. The system includes a centralized [symbol] _{∞} controller, a multi-agent system, and a distributed control. The centralized [symbol] _{∞} controller generates active and reactive power setpoints. The multi-agent system is integrated into the grid through a grid-tied inverter coupled with an LCL filter. The distributed control controls the multi-agent system and the grid-tied inverter to adjust output power of a multi-agent microgrid storage cooperatively so that they achieve consensus in the energy while providing inertial support.

### STATEMENT OF ACKNOWLEDGEMENT

The support of the Energy Research and Innovation Center (ERIC) at KFUPM and Qassim University is gratefully acknowledged.

### BACKGROUND

### Technical Field

The present disclosure is directed to a control system and method to regulate the frequency of islanded microgrids having low inertia levels and balance the state of charge of microgrid storage systems, acting as a grid-forming unit.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

A utility grid is a network of interconnected systems that transports electricity from a centralized power plant to consumers. For many years, the centralized power plant has been fueled by fossil-based generating units. To reduce the adverse effects, such as global warming and pollution, of fossil-based generating units, these centralized power plants are being replaced by decentralized smart microgrids. A smart microgrid incorporates distributed computer-based intelligence, bidirectional communications networks, and renewable-based distributed generation resources (DERs). Microgrids include a number of electronically coupled renewable energy sources (RESs), therefore having low rotating mass (i.e., source of inertia) as compared to conventional synchronous generators.

Due to low rotating mass, the stochastic nature of renewable energy sources (RESs), and sudden load changes, microgrids suffer from dynamic frequency stability issues, thereby restricting the maximum number of renewable-based distributed generation resources (DERs) that can be included in the utility grid. To facilitate the inclusion/penetration of DERs into the utility grid, it is required to address various problems including active and reactive power sharing, intermittency of renewable-based resources, non-inertial power sources, frequency regulation, current distortion, and voltage variability.

Incorporating renewable energy sources (RESs) in favor of conventional generators causes a reduction in the inertia levels, leading to significant transients and steeper rate of change of frequency (ROCOF) values. Most of the types of renewable energy sources (RESs) do not contribute to the system inertia due to the decoupling interface (i.e., power electronics devices) between the RESs and the microgrid. To mitigate such problems, a virtual synchronous generator (VSG) is used to provide synthetic inertia, imitating the action of traditional generators in providing inertial response during grid disruptions. The VSG enables the energy storage system (ESS) to behave as a traditional synchronous generator, exhibiting damping and inertia properties of conventional generators to the system.

A virtual-synchronous machine (VSM) has been introduced to provide frequency control services. When there is a change in load (decrease/increase), the frequency undergoes quick variation, even in case of systems with high inertia. For proper implementation of the VSM, an optimal sizing of energy storage is required depending on the variability of the injected power. Also, optimal use of a different storage mix, such as battery, ultracapacitors, or pumped storage system, needs to be explored for optimization of ESS. A consensus control in power system applications also needs to be employed to synchronize the power and state of charge (SOCs) of battery energy storage systems (BESSs).

In conventional control systems, inertia and damping properties of the microgrids must be precisely known when designing a stabilizing controller. Also, conventional control systems use simplified first-order transfer functions to represent the dynamics of the RESs alongside the ESS. The key limitation of these conventional systems is the controllers' degree of freedom, which sometimes exceeds the order of the microgrid dynamics, limiting their adoption in practical work.

Hence, there is a need for control solutions which can regulate the frequency of low inertial microgrids in an efficient and effective manner.

### SUMMARY

An aspect of the present disclosure is a control system to regulate frequency of an islanded microgrid is described. The islanded microgrid has at least one grid-tied renewable energy source. The control system a centralized [symbol] _{∞} controller, a multi-agent system, and a distributed control. The centralized [symbol] _{∞} controller generates active and reactive power setpoints. The multi-agent system is integrated into the grid through a grid-tied inverter coupled with an LCL filter. The multi-agent system is integrated into the grid through a grid-tied inverter coupled with an LCL filter. The distributed control controls the multi-agent system and the grid-tied inverter to adjust output power of a multi-agent microgrid storage cooperatively so that they achieve consensus in the energy while providing inertial support.

A further aspect of the present disclosure is a method of regulating frequency of an islanded microgrid, having at least one grid-tied renewable energy source. The method can include generating, by a centralized [symbol] _{∞} controller, active and reactive power setpoints; and controlling, by a distributed control, a multi-agent system, integrated into the grid through a grid-tied inverter coupled with an LCL filter, to adjust output power of a multi-agent microgrid storage cooperatively so that they achieve consensus in the energy while providing inertial support.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is an exemplary schematic diagram of a control system to regulate frequency of an islanded microgrid, according to certain embodiments.

FIG. 2 represents a small-signal model of electronically coupled distributed energy resources (DERs), according to certain embodiments.

FIG. 3 represents a small signal model of a phase-looked loop (PLL), according to certain embodiments.

FIG. 4 is a block diagram of a conventional high fidelity electrical model (battery model), according to certain embodiments.

FIG. 5 illustrates a small-signal model of a convex polytopic, according to certain embodiments.

FIG. 6 illustrates a communication model of a multi-agent system, according to certain embodiments.

FIG. 7A is an exemplary graph representing voltage waveforms of a grid-following (GFL) inverter, according to certain embodiments.

FIG. 7B is an exemplary graph representing current waveforms of the GFL inverter, according to certain embodiments.

FIG. 7C is an exemplary graph representing power waveforms of the GFL inverter, according to certain embodiments.

FIG. 7D is an exemplary graph representing voltage and current waveforms of the GFL inverter, according to certain embodiments.

FIG. 8A is an exemplary comparison graph representing frequency response of the microgrid when no control system is used versus a centralized [symbol] _{∞} controller is used respectively, according to certain embodiments.

FIG. 8B is another exemplary comparison graph representing frequency response of the microgrid when no control system is used versus a conventional proportional integral (PI) controller is used, according to certain embodiments.

FIG. 8C is another exemplary comparison graph representing frequency response of the microgrid when conventional PI controller is used versus the centralized [symbol] _{∞} controller is used, according to certain embodiments.

FIG. 8D is another exemplary comparison graph representing frequency response of the microgrid when no control system is used versus the centralized [symbol] _{∞} controller is used respectively, according to certain embodiments.

FIG. 9A is an exemplary graph representing dynamic analysis of a multi-agent system (MAS) over a time period of 0 to 80 minutes, according to certain embodiments.

FIG. 9B is an exemplary graph representing the dynamic analysis of the MAS over a time period of 0 to 45 minutes, according to certain embodiments.

FIG. 9C is another exemplary graph representing dynamic analysis of the MAS over a time period of 30 to 100 minutes, according to certain embodiments.

FIG. 9D is an exemplary graph representing state of charge (SOCs) of batteries connected with the MAS over a time period of 0 to 100 minutes, according to certain embodiments.

FIG. 10A is an exemplary graph representing grid frequency of the utility grid having the control system over a time period of 35 to 90 minutes, according to certain embodiments.

FIG. 10B is an exemplary graph representing dynamic analysis of the MAS having a virtual inertia support over a time period of 35 to 90 minutes, according to certain embodiments.

FIG. 10C is an exemplary graph representing dynamic analysis of the synchronous generator (SG) power over a time period of 35 to 90 minutes, according to certain embodiments.

FIG. 10D is an exemplary graph representing the SOCs of the batteries connected with the MAS, according to certain embodiments.

FIG. 11A is an exemplary graph representing frequency of the microgrid due to sudden disruption in the load, according to certain embodiments.

FIG. 11B is an exemplary graph representing power of the microgrid due to sudden disruption in the load, according to certain embodiments.

FIG. 11C is an exemplary graph representing decaying power of the microgrid due to sudden disruption in the load, according to certain embodiments.

FIG. 11D is another exemplary graph representing power of the MAS due to sudden disruption in the load, according to certain embodiments.

FIG. 11E is an exemplary graph representing SOCs of the MAS due to sudden disruption in the load, according to certain embodiments.

FIG. 11F is an exemplary graph representing frequency of the microgrid connected to the centralized [symbol] _{∞} controller due to sudden disruption in the load, according to certain embodiments.

FIG. 11G is an exemplary graph representing the power of the microgrid connected to the centralized [symbol] _{∞} controller due to sudden disruption in the load, according to certain embodiments.

FIG. 11H is an exemplary graph the decaying power of the microgrid connected to the centralized [symbol] _{∞} controller due to sudden disruption in the load, according to certain embodiments.

FIG. 11I is an exemplary graph representing the power of the MAS connected to the centralized [symbol] _{∞} controller due to sudden disruption in the load, according to certain embodiments.

FIG. 11J is an exemplary graph representing the SOCs of the MAS connected to the centralized [symbol] _{∞} controller due to sudden disruption in the load, according to certain embodiments.

FIG. 12 is an illustration of a non-limiting example of details of computing hardware used in the computing system, according to aspects of the present disclosure.

FIG. 13 is an exemplary schematic diagram of a data processing system used within the computing system, according to aspects of the present disclosure.

FIG. 14 is an exemplary schematic diagram of a processor used with the computing system, according to aspects of the present disclosure.

FIG. 15 is an illustration of a non-limiting example of distributed components that may share processing with the controller, according to aspects of the present disclosure.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of the present disclosure are directed to a control system to regulate frequency of an islanded microgrid and corresponding method. The present disclosure describes a centralized [symbol] _{∞} controller (H-infinity controller) and cooperative multi-agent consensus distributed control as a control approach to optimize the operation of the islanded microgrid. In control theory, a H-infinity control is used to synthesize a controller that can achieve stabilization with guaranteed performance. A controller is synthesized by expressing the control problem as a mathematical optimization problem that finds the controller that solves the optimization. In the distributed control approach, a group of subsystems or agents cooperatively interact to achieve consensus on a global objective. The centralized [symbol] _{∞} controller is configured to regulate the frequency of the islanded microgrid by emulating the inertial responses of synchronous generators (SGs). The centralized [symbol] _{∞} controller is also configured to synchronize the power and state of charge (SoC) for a group of batteries operating as a multi-agent system in the islanded microgrid.

In the present disclosure, the microgrid dynamics are transformed into a plurality of uncertain convex polytopic small-signal models using Lyapunov theories and linear matrix inequalities. Then, a convex optimization model is employed to allocate global setpoints to the centralized [symbol] _{∞} controller that stabilizes the microgrid over the uncertain polytope. The centralized [symbol] _{∞} controller (cooperative controller) aims to adjust the output power of the microgrid storage devices (battery energy storage devices) cooperatively so that they achieve consensus in the energy while providing inertial support. Using a real-time digital simulator (RTDS), a real-time simulation is carried out on a realistic microgrid to demonstrate the efficacy of the control approach. The multi-stage validation of the control system authenticates the robustness of the coordinated control design against various grid disruptions and a wide range of renewable injections.

In various aspects of the disclosure, non-limiting definitions of one or more terms that will be used in the document are provided below.

A microgrid can operate in two distinct modes: (1) grid connected and (2) islanded (autonomous) mode.

The “islanded” mode is a condition in which a microgrid, having distributed generation (DG) sources, converter, and load, gets disconnected from the utility grid. Under such condition the DG sources in the microgrid switches to a voltage control mode, in order to provide constant voltage to local loads.

A “grid connected mode” is a condition in which the microgrid works as current controller and injects power to the main grid, depending on the power generation and local load with suitable market policies. Providing constant voltage at a stable frequency with proper synchronization amongst each DG in a microgrid is a challenge.

A term “per-unit (pu)” may refer to an expression of system quantities as fractions of a defined base unit quantity.

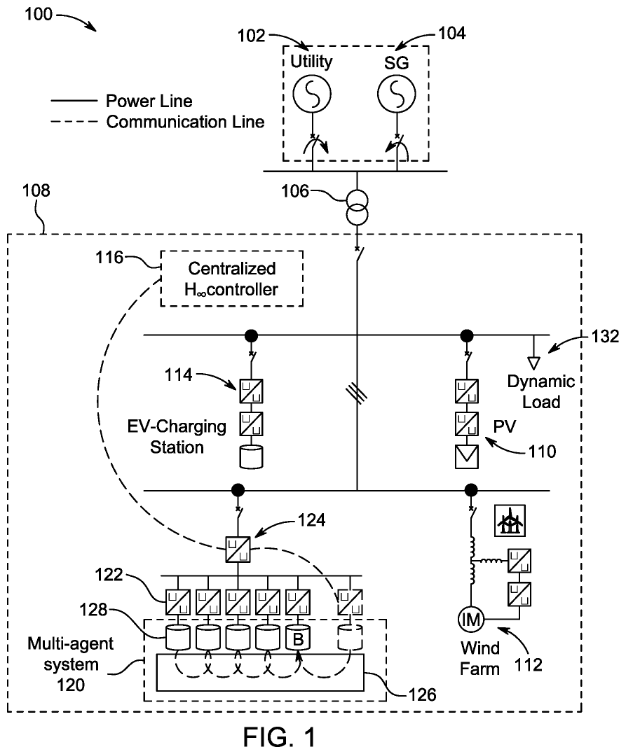

FIG. 1 illustrates an exemplary schematic diagram of a control system 100 to regulate frequency of an islanded microgrid 108, according to one or more aspects of the present disclosure. As shown in FIG. 1, the islanded microgrid 108 (“microgrid 108”) is connected to a utility grid 102 through a point of common coupling (PCC) 106.

The utility grid 102 (hereinafter interchangeably referred to as “the grid”) is an interconnected network that delivers electricity from power-producing stations to consumers. The utility grid 102 includes various units such as a power generation unit, a power transportation unit for carrying the generated power from the power generation unit to the consumer side, and a substation unit (not shown) connected to the power transportation unit for receiving the generated power as well as converting into a required power suitable for household or industries loads. The utility grid 102 is configured to operate at a utility grid voltage, a utility grid frequency, and a utility grid phase angle.

As shown in FIG. 1, the islanded microgrid 108, includes a synchronous generator (SG) 104, a doubly fed induction generator (not shown in FIG), at least one grid-tied renewable energy source, and a dynamic (composite) load 132. In an example, the at least one renewable energy source is a photovoltaic (PV) system 110, a wind turbine system 112, and a grid-tied electric vehicles charging station 114. In practical, a microgrid is a mixture of conventional and electronically coupled Distributed Energy Resources (DERs).

In an aspect, the PCC 106 is a point at which the islanded microgrid 108 is interfaced with the utility grid 102. In an example, the PCC 106 is a DC bus through which the islanded microgrid 108 is interfaced with the at least one grid-tied renewable energy source and the dynamic load 132. In some examples, the PCC 106 acts as an interface through which the generated energy from the renewable energy sources passes to an external network, such as a utility. In an aspect, the PCC 106 is a common interconnection point for different customers connected to the same utility power supply. In an example, the PCC 106 is connected to the plurality of power converters. The DC bus is configured to receive the DC voltage from the plurality of power converters.

The synchronous generator (SG) 104 generates power by rotation of a rotor and supplies the generated electric power to the utility grid 102. The synchronous generator 104 is configured to operate in a P-V (constant active power and terminal voltage) mode or a P-Q (constant active and reactive power) mode. The synchronous generator 104 follows the grid frequency and delivers the required power to the grid 102 by applying the required amount of torque calculated by a generator governor.

The at least one grid-tied renewable energy source is configured to generate an electric current. The renewable energy source is configured to employ a maximum power point tracking (MPPT) algorithm. The renewable energy source includes a DC-DC converter that converts a direct current (DC) from one voltage level to another level. The DC-DC converter is configured to produce a voltage that is regulated and consistent.

In an embodiment, the PV system 110 includes at least two PV modules, and a DC/DC converter, such that the solar energy is converted into electric energy and transmitted to a direct current bus. In an example, the PV system 110 includes a power inverter which converts the direct current (DC) output of the PV system 110 into a utility frequency alternating current (AC) that can be fed into a commercial electrical grid or used by a local, off-grid electrical network. In an embodiment, the MPPT algorithm is implemented in the plurality of inverters coupled with the renewable energy generating devices. For example, the MPPT algorithm is configured to continuously adjust an impedance of the PV system 110 to keep the PV array operating at, or close to, the peak power point of the PV system 110 under varying conditions, like changing solar irradiance, temperature, and load. The MPPT algorithm controls the voltage to ensure that the system operates at “maximum power point” (or peak voltage) on a power voltage curve.

The wind turbine system 112 (also known as “grid-tied wind system”) is configured to convert the wind energy into electric energy. The wind turbine system 112 includes a doubly fed induction generator, a synchronous generator, an AC-DC converter and a DC-DC voltage stabilizing module which are sequentially connected to convert the wind energy into the electric energy. The wind turbine system 112 also includes the maximum power point tracking (MPPT) algorithm. The MPPT algorithm is configured to change the output voltage of the wind turbine system 112 to track the maximum power point.

The grid-tied electric vehicle (EV) charging station 114 is connected to the grid 102 or with the microgrid 108 ensuring quality power transfer with reduced harmonic currents. The EV charging station 114 includes an AC-DC grid tied converter, and a DC bus. The DC bus is configured to connect the renewable energy sources directly through a DC-DC converter. For example, a three phase supply is taken from the grid. A three phase transformer is used to step down the voltage from the distribution grid voltage level to EVs battery voltage levels. Also a three phase AC/DC converter transforms the ac power into dc power and forms the DC bus. EVs get connected to the DC bus for charging through DC/DC converters.

The dynamic load 132 is connected to the islanded microgrid 108 via the PCC 106. Endpoints of the islanded microgrid 108 are consumer locations where electricity is used to power various equipment such as lighting equipment, television devices, dishwasher equipment, or such equipment (acting as multiple loads 132 for the microgrid 108). In an example, a DC load is connected to the PCC 106 via a DC-DC converter. In another example, an AC load is connected to the PCC 106 via a DC-AC converter that converts DC (direct current) to AC (alternating current).

Referring to FIG. 1, the control system 100 includes a centralized [symbol] _{∞} controller 116, a multi-agent system 120, and a distributed control 126.

The centralized [symbol] _{∞} controller 116 (cooperative controller) is configured to generate an active power setpoint and a reactive power setpoint. The centralized [symbol] _{∞} controller 116 regulates the frequency of the islanded microgrid 108. The centralized [symbol] _{∞} controller 116 is configured to output a feedback that minimizes the maximum gain of the output over disturbances.

The multi-agent system 120 is integrated into the grid through a grid-tied inverter 122 coupled with an LCL filter 124. In an embodiment, the multi-agent system 120 includes multiple autonomous computational entities (agents), which perform tasks based on goals. The multi-agent system 120 includes a multi-agent microgrid storage 128 (a group of battery energy storage devices). The group of battery energy storage devices 128 is attached to the DC-link of the grid-tied inverter 122.

It is known in the art that in a system with lower inertia, the frequency nadir is considerably lower along with a high rate of change of frequency (ROCOF). The frequency nadir is used to predict a maximum frequency deviation and a time at which the maximum frequency deviation occurs after a major disturbance. Such situations can lead to under-frequency load shedding (UFLS), and cascaded outages. The solution to such scenarios is to add virtual inertia in the control system 100. In the present control system 100, a virtual inertial unit (virtual synchronous generator (VSG) frequency-based unit) is integrated into the islanded microgrid 108 through the grid-tied inverter 122 (a three-phase grid-connected inverter), thereby enhancing system stability and enable greater penetration of RESs into the microgrid 108. The virtual inertial unit receives the active and reactive power setpoints and enhances the centralized [symbol] _{∞} controller to exhibit damping and inertia properties of the synchronous generator.

The distributed control 126 is configured to control the multi-agent system 120 and the grid-tied inverter 122 to adjust output power of the multi-agent microgrid storage 128 cooperatively so that they achieve consensus in the energy while providing inertial support. The distributed control 126 is a decentralized cooperative multi-agent control to synchronize the power and state of charge (SOCs) among the battery energy storage devices of the multi-agent microgrid storage 128.

In the present control system 100, microgrid dynamics are transformed into various uncertain convex polytopic small-signal models using Lyapunov theories and linear matrix inequalities. A convex optimization model is solved to allocate the active and reactive power setpoints to the centralized [symbol] _{∞} controller that stabilizes the microgrid 108 over the uncertain convex polytope.

The H-infinity controller is expressed as a mathematical optimization problem, and the controller that solves the optimization is used as the controller. During the realization of the control system 100, following mathematical relationships (theories) are considered:

### Algebraic Graph Theory

Graph theory is a mathematical framework for modeling interconnection between the plurality of agents in the multi-agent system. A graph [symbol] ( [symbol] , E) is defined as an ordered pair of a set of vertices [symbol] and edges ε. The information in the graph is characterized by the degree, adjacency, incidence, and Laplacian matrices. For a graph containing n vertices and m edges, the degree matrix Δ( [symbol] )∈ [symbol] ^{n×n}, is a diagonal matrix having elements on the diagonal representing the degree d(vᵢ) of each vertex. d(vᵢ) is the sum of edges incident to the vertex vᵢ. The adjacency matrix [symbol] ( [symbol] ) is a symmetric n×n matrix describing the adjacency relationship in [symbol] . aᵢⱼ∈ [symbol] ( [symbol] )=1 if vᵢvⱼ∈ε( [symbol] ) and zero otherwise. Laplacian matrix in an undirected graph [symbol] ( [symbol] )=Δ( [symbol] )− [symbol] ( [symbol] ). The Laplacian matrix dictates the stability and convergence rate of the multi-agent system.

The multi-agent system 120 is configured to employ a distributed control to synchronize the power and state of charge (SOCs) among the battery energy storage devices. The distributed control 126 is a decentralized cooperative multi-agent control. The distributed control 126 (multi-agent control) operates according to a coordinated leader-follower control approach which is configured to balance the SOC of the battery energy storage devices, by adjusting output power of operative batteries to balance the SOC while providing inertial support to the microgrid 108. The distributed control 126 ensures that no battery is depleted when available capacity exists in the remaining battery energy storage devices.

To develop the distributed control 126 (decentralized cooperative multi-agent control), following assumptions are considered:

In first assumption, an average consensus is considered. It is also known as leaderless consensus protocol. For the leaderless consensus protocol, consider a network of multi-agent systems (MAS) [symbol] having n agents described by the following first-order dynamics:

$${\dot{x}}_{i} ( t ) = {u}_{i} ( t ) i = 1 , 2 , ... n , \qquad ( 1 )$$

where xᵢ and uᵢ represent the states input and control input of each agent in the network.

The MAS [symbol] described by \dot{x}ᵢ achieves consensus if for any xᵢ(0),

$${lim}_{t \to ∞} \vert {x}_{i} ( t ) - {x}_{j} ( t ) \vert = 0 ∀ i , j = 1 , 2 , .. n \qquad ( 2 )$$

The MAS asymptotically solves average-consensus problem when,

$${lim}_{t \to ∞} \vert {x}_{i} ( t ) \vert = \frac{1}{n} {\sum }_{j = 1}^{n} {x}_{j} ( 0 ) ∀ i , j = 1 , 2 , .. n . \qquad ( 3 )$$

The control protocol uᵢ(t) is chosen as,

$${u}_{i} ( t ) = - {\sum }_{j = 1}^{n} {a}_{ij} ( {x}_{i} ( t ) - {x}_{j} ( t ) ) j = 1 , 2 , ... n . \qquad ( 4 )$$

In an example, a closed loop system (under the consensus protocol uᵢ) is given as,

$$\dot{x} = - ℒ x , \qquad ( 5 )$$

where [symbol] has a simple zero eigenvalue and all other eigenvalues have positive real parts. [symbol] x=0 implies that x₁=x₂= . . . xₙ. Consensus is reached asymptotically for the system \dot{x}=− [symbol] x.

The centralized [symbol] _{∞} controller 116 provides the feedback for minimizing the maximum gain of the output of the microgrid 108 over disturbances. In an example, the disturbances include power injections from the at least one grid-tied renewable energy source. The centralized [symbol] _{∞} controller 116 is configured to provide a robust [symbol] _{∞} control ( [symbol] _{∞} control is used to shape closed loop transfer functions and guarantee closed loop stability), as evaluated in the following equations:

Consider a linear time-invariant system (LTI) given by equation 6-equation 9, as below,

$$\overline{x} ( t ) = {A}_{Sys} \overline{x} ( t ) , \qquad ( 6 )$$

$${A}_{Sys} = [ \begin{matrix}{A}^{n \times n} & {B}_{2}^{n \times r} & {B}_{1}^{n \times q} \\ {C}_{1}^{p \times n} & {D}_{12}^{p \times r} & {D}_{11}^{p \times q} \\ {C}_{2}^{m \times n} & {D}_{22}^{m \times r} & {D}_{21}^{m \times q}\end{matrix} ] , \qquad ( 7 )$$

$$\overline{x} ( t ) = {[ \begin{matrix}\dot{x} ( t ) & z ( t ) & y ( t )\end{matrix} ]}^{T} , \qquad ( 8 )$$

$$\overline{x} ( t ) = {[ \begin{matrix}x ( t ) & u ( t ) & w ( t )\end{matrix} ]}^{T} , \qquad ( 9 )$$

where x∈ [symbol] ⁿ is the state variable. w∈ [symbol] ^{q} and u∈ [symbol] ^{r} denote the disturbance and the actual system input, respectively. z∈ [symbol] ^{p} and y∈ [symbol] ^{m} denote a controlled output and a measured output, respectively. The mandate of the [symbol] _{∞} control is to minimize the maximum gain of the output over the disturbances. That is,

$${‖ {G ( s )}_{w \to z} ‖}_{∞} := {sup}_{w \neq 0} \frac{{‖ z ‖}_{l 2}}{{‖ ω ‖}_{l 2}} \leq {γ}^{2} . \qquad ( 10 )$$

G(s) denotes the transfer function that lives in the hardy space [symbol] _{∞}( [symbol] ₊). The ∥⋅∥_{∞} of G is the supremum of the maximum singular values in the frequency domain. z and w refer to the system output and the exogenous input, respectively.

The state-space realization given by equation (6) is [symbol] _{∞} static output feedback stabilizable if (A, B₂) is stabilizable and (A, C₂) is detectecble, and there exists a symmetric matrix P>0 such that,

$$η := [ \begin{matrix}Sym \{ {P ( A + B 𝒦 {C}_{2} )}^{T} \} & {B}_{c} & {PC}_{c}^{T} \\ * & - γ I & {D}_{c}^{T} \\ * & * & - γ I\end{matrix} ] , \qquad ( 11 )$$

$${B}_{c} = {B}_{1} , {C}_{c} = {C}_{1} + {D}_{12} 𝒦 {C}_{2} , {D}_{c} = {D}_{11} , \qquad ( 12 )$$

where Sym{ψ} stands for the argument {ψ+ψ^{T}}. P is a positive definte matrix of an appropriate dimension satisfying P=P^{T}. Although A and C₂ are both affine in the controller [symbol] , the matrix inequality (equation 11) is bilinear in terms of P and [symbol] , therefore, equation (11) is non-convex and NP-hard to solve. However, equation (11) is a necessary and sufficient condition for the stability and stabilization of the system. Also, the level of complexity increases if the matrices in equation (6) become functions of system uncertainties.

In the present disclosure, various state-space models that are perturbed versions of the nonlinear small-signal models are employed. In control field, a state-space model is a mathematical model of a physical system specified as a set of input, output and variables (state variables) related by first order (not involving second derivatives) differential equations or difference equations. The values of the output variables depend on the values of the state variables.

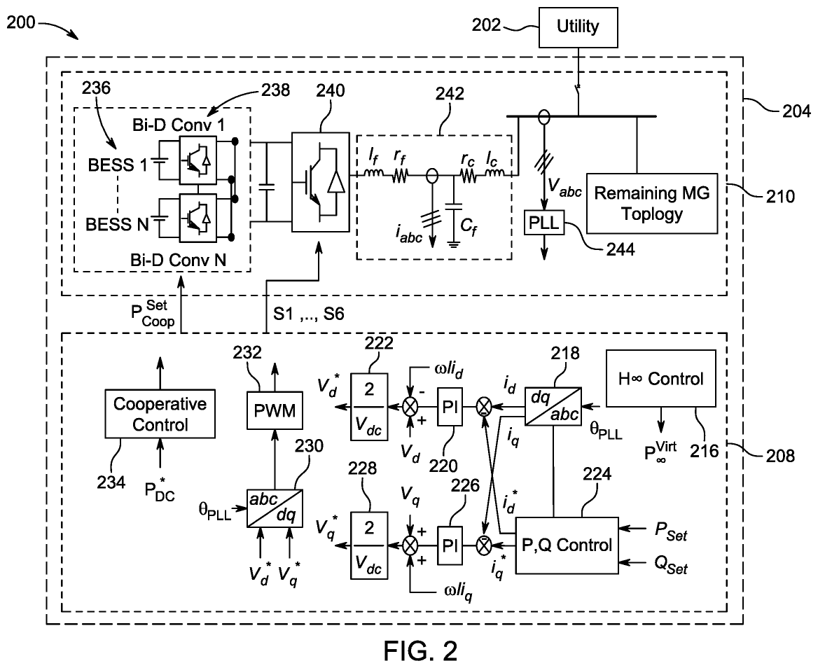

FIG. 2 represents a small-signal model 200 of electronically coupled distributed energy resources (DERs), according to certain embodiments.

As shown in FIG. 2, the centralized [symbol] _{∞} controller 216 is configured to employ the distributed control to synchronize the power and state of charge (SOCs) among the battery energy storage devices. The grid-tied inverter includes a phase-locked loop (PLL), a current controller, and the LCL filter. The small-signal model 200 is a tenth-order small-signal model that represents the dynamics of the phase-locked loop, the current controller, and the LCL filter.

The microgrid 204 is connected to the utility grid 202 via the PCC 206. The microgrid 204 can be divided into two sections, a control section 208 and a distributed energy resources (DERs) section 210. The DER is small-scale power generation sources which are located close to where electricity is used (e.g., a home or business) and provide an alternative to an electric power grid.

The control section 208 is configured to receive an input signal (θ_{PLL}) from the centralized [symbol] _{∞} controller 216. The control section 208 uses dq control as shown by block 218. In an example, the dq control converts grid voltage and current into a frame that rotates synchronously with the grid voltage vector by Park Transformation so that three-phase time-varying signals are transformed into DC signals. Block 218 (dq transformation) is configured to generate i_{d}, and i_{q}.

Similarly, block 224 is configured to employ PQ control and generate i_{d}*, and i_{q}*. The PQ control is configured to generate a reference voltage that is used to control both the active and reactive power. Further, an input signal (i_{d}−i_{d}*) is provided to a first PI controller 220 and an input signal (i_{q}−i_{q}*) is given to a second PI controller 226. The first PI controller 220 generates a first reference current required for voltage regulation. The second PI controller 226 generates a second reference current required for voltage regulation. Block 222

$$( \frac{2}{{v}_{dc}} )$$

is configured to generate a first reference PWM signal (v_{d}*). Block 228

$$( \frac{2}{{v}_{dc}} )$$

is configured to generate a second reference PWM signal (v_{q}*). Block 230 is configured to receive the first reference PWM signal (v_{d}*) and the second reference PWM signal (v_{q}*) from the block 222 and the block 228, respectively. The block 230 also receives the input signal (θ_{PLL}) from the centralized [symbol] _{∞} controller 116 and generates a signal for a PWM 232. The PWM 232 is responsible for the generation of the gating signals sent to the battery energy storage devices.

Block 234 is configured to receive a reference DC (P_{DC}*) signal and employ a cooperative control to synchronize the power and state of charge (SOCs) among the battery energy storage devices. As shown in FIG. 2, the control section 208 is configured to generate a P_{Coop}^{Set} to be fed to the DERs section 210.

The DERs section 210 includes a plurality of BESSs 236, a plurality of DC-DC converters 238, a LCL filter 242, and a phase-locked loop (PLL) 244. For example, the plurality of BESSs 236 includes N BESS. Each of the plurality of BESSs 236 is connected to a bidirectional buck-boost DC-DC converter 238. The bidirectional buck-boost DC-DC converter is attached with every BESS in the multi-agent system 120 to provide fully-fledged lower-level controls. Block 240 is configured to act as a current path. In an example, the block 240 includes a power inverter that changes direct current (DC) to alternating current (AC).

The PLL 244 is configured to generate an output signal whose phase is related to the phase of an input signal (for example, phase of the microgrid). The LCL filter 242 is configured to reduce harmonics of current absorbed by the power converters 240, with a rectifier input stage. The dynamics of the LCL filter 242 in dq frame may be described by the following sets of dynamical equations. The inductor current of the filter in dq frame is given by,

$$\begin{matrix}\frac{d {i}_{L d}}{d t} = - \frac{{R}_{f}}{{L}_{f}} {i}_{L d} - \frac{1}{{L}_{f}} ( {v}_{c d} - {v}_{i n v d} ) + ω {i}_{L q} \\ \frac{d {i}_{L q}}{d t} = - \frac{{R}_{f}}{{L}_{f}} {i}_{L q} - \frac{1}{{L}_{f}} ( {v}_{c d} - {v}_{i n v d} ) - ω {i}_{L d}\end{matrix} , \qquad ( 13 )$$

where i_{L}, vᵢₙᵥ, R_{f}, L_{f}, v_{c}, and ω denote the inverter current and voltage, filter resistance and inductance, and capacitor voltage and synchronous speed, respectively. Similarly, the output current sensed at the grid side of the inverter is given by,

$$\begin{matrix}\frac{d {i}_{o d}}{d t} = - \frac{{R}_{c}}{{L}_{c}} {i}_{o d} + \frac{1}{{L}_{c}} ( {v}_{C d} - {v}_{g d} ) + ω {i}_{o q} \\ \frac{d {i}_{o q}}{d t} = - \frac{{R}_{c}}{{L}_{c}} {i}_{o q} + \frac{1}{{L}_{c}} ( {v}_{C q} - {v}_{g d} ) - ω {i}_{o d}\end{matrix} , \qquad ( 14 )$$

R_{f} and L_{f} are the coupling resistance and inductance, respectively. v_{g} stands for the grid voltage. The output voltage across the capacitor terminals can be described by,

$$\begin{matrix}\frac{{dv}_{cd}}{d t} = \frac{1}{{C}_{f}} ( {i}_{Ld} - {i}_{od} ) + ω {v}_{Cq} \\ \frac{{dv}_{cq}}{d t} = \frac{1}{{C}_{f}} ( {i}_{Lq} - {i}_{oq} ) + ω {v}_{Cd}\end{matrix} . \qquad ( l5 )$$

The small-signal model of the LCL filter in the compact form is given by,

$${\dot{x}}_{f} = {A}_{f} {x}_{f} + {B}_{f} {u}_{f} \qquad ( 16 )$$

where A_{f} is given as,

$${A}_{f} = [ \begin{matrix}- \frac{{R}_{f}}{{L}_{f}} & ω & 0 & 0 & - \frac{1}{{L}_{f}} & 0 \\ - ω & - \frac{{R}_{f}}{{L}_{f}} & 0 & 0 & 0 & - \frac{1}{{L}_{f}} \\ 0 & 0 & - \frac{{R}_{f}}{{L}_{c}} & ω & \frac{1}{{L}_{f}} & 0 \\ 0 & 0 & - ω & 0 & 0 & - \frac{1}{{C}_{f}} \\ \frac{1}{{C}_{f}} & 0 & - \frac{1}{{C}_{f}} & 0 & 0 & ω \\ 0 & \frac{1}{{C}_{f}} & 0 & - \frac{1}{{C}_{f}} & - ω & 0\end{matrix} ] . \qquad ( l7 )$$

The input matrix B_{f} to the LCL filter is decoupled to,

$${B}_{f}^{1} = {[ \begin{matrix}\frac{1}{{L}_{f}} & 0 & 0 & 0 & 0 & 0 \\ 0 & \frac{1}{{L}_{f}} & 0 & 0 & 0 & 0\end{matrix} ]}^{T} , \qquad ( 18 )$$

$${B}_{f}^{2} = {[ \begin{matrix}0 & 0 & - \frac{1}{{L}_{c}} & 0 & 0 & 0 \\ 0 & 0 & 0 & - \frac{1}{{L}_{c}} & 0 & 0\end{matrix} ]}^{T} , \qquad ( 19 )$$

Where x_{f}, u_{f}, and y_{f} are as follows,

$$\begin{matrix}{x}_{f} = {[ \begin{matrix}{i}_{L d} & {i}_{L q} & {i}_{o d} & {i}_{o q} & {v}_{c d} & {v}_{c q}\end{matrix} ]}^{T} \\ {u}_{f} = [ {\begin{matrix}{v}_{i n v d} & {v}_{i n v q} & {v}_{g d} & {v}_{gq} ]\end{matrix}}^{T} \\ {y}_{f} = {[ \begin{matrix}{i}_{L d} & {i}_{L q} & {i}_{o d} & {i}_{o q} & {v}_{c d} & {v}_{c q}\end{matrix} ]}^{T}\end{matrix} . \qquad ( 20 )$$

The power controller is an open-loop conversion of a power reference into a current reference, given the voltage at the PCC. The output reference currents can be calculated using active and reactive power setpoints as follows,

$$\begin{matrix}P = {v}_{o d} {i}_{ld} + {v}_{o q} {i}_{lq} \\ Q = {v}_{o q} {i}_{ld} - {v}_{o d} {i}_{lq}\end{matrix} . \qquad ( 21 )$$

A voltage source inverter (VSI) is operated at a unity power factor under which the d-axis is aligned with the magnitude of the grid voltage and the q-axis is set to zero (i.e., v_{oq}=0). The reference currents can be obtained from the following notions,

$$\begin{matrix}{i}_{ld}^{⋆} = \frac{{P}_{set}}{{v}_{o d}} \\ {i}_{lq}^{⋆} = \frac{{Q}_{set}}{{v}_{o d}}\end{matrix} . \qquad ( 22 )$$

A factor of 3/2 may be added to the previous notions if Clarke's transformation is used instead of Concordia's.

A PQ inverter and the grid-tied inverter 122 (current controller) are designed and controlled to track the setpoints dictated by system operators. Generally, the grid-tied inverters do not inherently participate in frequency and voltage regulations. Therefore, the control system 100 of the PQ inverter basically relies on the current controller block for tracking purposes. The dynamics of the current controller can be described by,

$$\begin{matrix}{\dot{γ}}_{d} = {i}_{L d}^{*} - {i}_{L d} \\ {\dot{γ}}_{q} = {i}_{L q}^{*} - {i}_{L q}\end{matrix} . \qquad ( 23 )$$

The inverter voltage in the dq rotating frame is given as,

$$\begin{matrix}{v}_{i n v d} = - ω {L}_{f} {i}_{L q} + {k}_{p c} ( {i}_{L d}^{*} - {i}_{L d} ) + {k}_{i c} {γ}_{d} \\ {v}_{i n v q} = ω {L}_{f} {i}_{L d} + {k}_{p c} ( {i}_{L q}^{*} - {i}_{L q} ) + {k}_{i c} {γ}_{q}\end{matrix} \qquad ( 24 )$$

The small-signal model of the current controller is given by,

$$[ \begin{matrix}{\dot{γ}}_{d} \\ {\dot{γ}}_{q}\end{matrix} ] = [ \begin{matrix}0 & 0 \\ 0 & 0\end{matrix} ] [ \begin{matrix}{γ}_{d} \\ {γ}_{q}\end{matrix} ] + [ \begin{matrix}1 & 0 & - 1 & 0 \\ 0 & 1 & 0 & - 1\end{matrix} ] [ \begin{matrix}{i}_{ld}^{⋆} \\ {i}_{l q}^{*} \\ {i}_{ld} \\ {i}_{l q}\end{matrix} ] \qquad ( 25 )$$

Similarly, composing vᵢₙᵥ in the compact form yields,

$$[ \begin{matrix}{v}_{i n v d} \\ {v}_{i n v q}\end{matrix} ] = [ \begin{matrix}{k}_{i c} & 0 \\ 0 & {k}_{i c}\end{matrix} ] [ \begin{matrix}{γ}_{d} \\ {γ}_{q}\end{matrix} ] + [ \begin{matrix}{k}_{pc} & 0 & - {k}_{pc} & - ω {L}_{f} \\ 0 & {k}_{pc} & ω {L}_{f} & - {k}_{pc}\end{matrix} ] [ \begin{matrix}{i}_{ld}^{⋆} \\ {i}_{l q}^{*} \\ {i}_{ld} \\ {i}_{l q}\end{matrix} ] \qquad ( 26 )$$

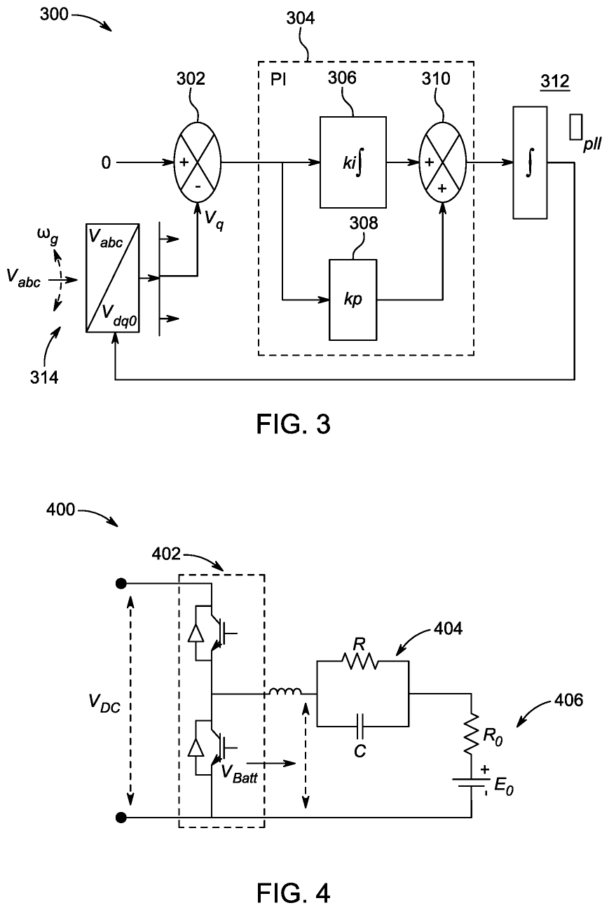

FIG. 3 represents a small signal model 300 of the phase-looked loop (PLL), according to certain embodiments. PLL is an integral unit of any grid tied system which helps in synchronization of any inverter-based distributed energy source to the utility. The PLL needs the three phase voltages (a, b, c) of the grid, and the output of the PLL is the phase angle θ_{PLL}. The PLL controls the phase angle through the processing of a PI regulator; thus, the three-phase sinusoidal voltages have a transformation in the referential state (d, q). This quadrature axis voltage is processed by the PI controller in which the angular velocity of the electrical grid is obtained, until this signal approaches zero, thus ensuring the alignment of the direct axis d with the electrical grid vector, which allows us to infer that there is a synchronism between the grid and the microgrid.

Block 304 is a low-pass filter (LPF). For example, the LPF is a PI controller. The PI controller 304 is formed by combining a proportional and an integral control action. The PI controller 304 includes two paths: an integral path (kᵢ∫) 306, and a proportional path (kₚ) 308. In an example, the proportional path (kₚ) 308 tends to react on error and the integral term tends to integrate the error such that the PI controller 304 eventually produces a control output that drives the current error to zero. Block 310 is configured to add the output generated by the integral path (kᵢ∫) 306, and the proportional path (kₚ) 308.

Block 312 represents to a voltage controlled oscillator (VCO) which is configured to generate an output frequency. The output frequency is proportional to an input voltage of the VCO. Block 314 is configured to act as a feedback control that receives the output frequency from the VCO and phase voltage of the grid. Block 314 employs dq control and generates a DC signal v_{q}. Block 302 is an adder.

The dynamics of PLL is attached to the grid-connected converters' overall model is fundamental for synchronization. The small signal model of the PLL shown in FIG. 3, is given as,

$${\dot{x}}_{2} = [ \begin{matrix}0 & {K}_{I}^{PLL} \\ 0 & 0\end{matrix} ] [ \begin{matrix}{θ}_{P L L} \\ {Φ}_{P L L}\end{matrix} ] + [ \begin{matrix}{K}_{P}^{PLL} {v}_{o q} \\ {v}_{o q}\end{matrix} ] \qquad ( 27 )$$

where x₂=[θ_{PLL}Φ_{PLL}]^{T} and the output is given by,

$$y = {[ \begin{matrix}{θ}_{P L L} & {v}_{o d} & {v}_{o q}\end{matrix} ]}^{T} \qquad ( 28 )$$

The overall small-signal model of the grid-follower inverter in the compact form is composed as,

$$\begin{matrix}\dot{x} = {A}_{p q} x + {B}_{p q} u \\ y = Cx\end{matrix} \qquad ( 29 )$$

where x and A_{pq} are written as,

$$x = {[ \begin{matrix}{θ}_{P L L} & {Φ}_{P L L} & {γ}_{d} & {γ}_{q} & {i}_{L d} & {i}_{L q} & {v}_{c d} & {v}_{c q} & {i}_{o d} & {i}_{o q}\end{matrix} ]}^{T} \qquad ( 30 )$$

$${A}_{p q} = [ \begin{matrix}{A}_{P L L}^{2 \times 2} & {0}^{2 \times 2} & {0}^{2 \times 6} \\ {0}^{2 \times 2} & {A}_{C \_ Controller}^{2 \times 2} & {0}^{2 \times 6} \\ {0}^{6 \times 2} & {0}^{6 \times 2} & {A}_{f}^{6 \times 6}\end{matrix} ] \qquad ( 31 )$$

Without loss of generality, the input to the PQ inverter can be in the form of,

$$u = {[ {P}_{ref}^{*} {Q}_{ref}^{*} {v}_{o d} {v}_{o q} ]}^{T} \qquad ( 32 )$$

In the present disclosure, a small signal model of synchronous generator (SG) is also analyzed. In an example, a synchronous generator's seventh-order model is used to capture the stator and rotor dynamics. The SG model in the compact form is written as,

$${E}_{S G} \dot{x} = {F}_{S G} x + {B}_{S G} u \qquad ( 33 )$$

where x∈ [symbol] ⁿ and u∈ [symbol] ^{m} denote the state variables and the input to SG, respectively. F∈ [symbol] ^{n×n} is provided in the appendices. The matrices E∈ [symbol] ^{n×n} and B∈ [symbol] ^{n×m} given below, characterize the dynamics evolution with time and the input matrix, respectively. The initial conditions can be readily obtained from the load flow analyses and the algebraic equations linking the flux linkages to stator and rotor currents.

$${E}_{S G} = [ \begin{matrix}{L}_{d} & {M}_{F} & {M}_{D} & 0 & 0 & 0 & 0 \\ {M}_{F} & {L}_{F} & {M}_{R} & 0 & 0 & 0 & 0 \\ {M}_{D} & {M}_{R} & {M}_{D} & 0 & 0 & 0 & 0 \\ 0 & 0 & 0 & {L}_{q} & {M}_{Q} & 0 & 0 \\ 0 & 0 & 0 & {M}_{Q} & {L}_{Q} & 0 & 0 \\ 0 & 0 & 0 & 0 & 0 & 1 & 0 \\ 0 & 0 & 0 & 0 & 0 & 0 & 2 H {ω}_{o}\end{matrix} ] \qquad ( 34 )$$

where x and the B_{SG} are given as,

$$x = {[ \begin{matrix}{i}_{d} & {i}_{F} & {i}_{D} & {i}_{q} & {i}_{Q} & δ & ω\end{matrix} ]}^{T} \qquad ( 35 )$$

$${B}_{S G} = {[ \begin{matrix}0 & - {v}_{F} & 0 & 0 & 0 & 0 & {T}_{M}\end{matrix} ]}^{T} \qquad ( 36 )$$

FIG. 4 is a block diagram 400 of a conventional high fidelity electrical model (battery model), according to certain embodiments. Block 402 acts a current path. In the block 402, a path to current is provided based on a switching state of two switching devices. Block 402 includes two half bridges having two complementary switches. RC block 404 includes a resistor (R) in parallel with a capacitor (C). The single RC block 404 is used to account for the discharge dynamics observed in the BESS system. For example, the RC block 404 provides all dynamic characteristics of a cell (battery), including nonlinear open-circuit voltage, average discharge current and inner cell temperature. Block 406 is configured to generate a DC output.

In the present disclosure, a small signal model of the microgrid storage 128 (BESS system) is also analyzed. In an example, the microgrid storage 128 operate in a decentralized microgrids and are usually situated behind bidirectional DC-DC converters. It is necessary to attach a bidirectional buck-boost DC-DC converter for every battery module in the multi-agent system 120 to have fully-fledged lower-level controls. In the present disclosure, the dynamics of the aggregated system are given as,

$$\begin{matrix}\frac{{di}_{L}}{d t} = - \frac{{r}_{o}}{L} {i}_{L} - \frac{1}{L} {v}_{c} + \frac{{v}_{dc}}{L} d - {e}_{o} \\ \frac{d {v}_{c}}{d t} = \frac{1}{{C}_{b}} {i}_{L} - \frac{1}{{r}_{b} {C}_{b}} {v}_{c} \\ \frac{d {e}_{o}}{d t} = 0\end{matrix} , \qquad ( 37 )$$

where i_{L}, v_{c}, v_{dc}, and eₒ refer to the bidirectonal converter current, capacitor voltage, input voltage, and the internal electromotive force, respectively.

The small-signal model of the BESS system is written as,

$$\frac{d}{d t} [ \begin{matrix}{i}_{L} \\ {v}_{c} \\ {e}_{o}\end{matrix} ] = [ \begin{matrix}- \frac{{r}_{o}}{L} & - \frac{1}{L} & - 1 \\ \frac{1}{{C}_{b}} & - \frac{1}{{r}_{b} {C}_{b}} & 0 \\ 0 & 0 & 0\end{matrix} ] [ \begin{matrix}{i}_{L} \\ {v}_{c} \\ {e}_{o}\end{matrix} ] + [ \begin{matrix}\frac{{V}_{dc}}{L} \\ 0 \\ 0\end{matrix} ] d . \qquad ( 38 )$$

The output is chosen as,

$${y}_{B} = [ \begin{matrix}1 & 0 & 0 \\ {r}_{o} & 1 & 1\end{matrix} ] [ \begin{matrix}{i}_{L} \\ {v}_{c} \\ {e}_{o}\end{matrix} ] . \qquad ( 39 )$$

A proportional-integral-based lower-level controller (PI controller) is attached to the model to regulate the duty cycle of the converter. The PI controller is given as,

$$u ( t ) = d ( t ) = {K}_{p} e ( t ) + {K}_{i} \int e ( t ) d t . \qquad ( 40 )$$

Where the dynamics of the integral controller read as follows,

$$\frac{d ϕ}{d t} = {i}_{d c}^{*} - {i}_{L} . \qquad ( 41 )$$

The distributed control is designed to track the reference current (i.e., charging or discharging orders) generated by a multi-agent consensus controller.

$${i}_{d c}^{*} = \frac{{P}_{dc}^{⋆}}{{V}_{B a t t}} . \qquad ( 42 )$$

The dynamic model of the SOC of an ESS is given by,

$$\begin{matrix}{s}_{i} ( t ) = {s}_{i} ( 0 ) - \frac{{ρ}_{i}}{{q}_{i}} {\int }_{0}^{t} {I}_{i} ( t ) dt & i ∈ V\end{matrix} , \qquad ( 43 )$$

where sᵢ(t), Iᵢ(t), and qᵢ are the state-of-charge, output current, and capacity of the i^{th} ESS, respectively. ρᵢ denotes the coulombic efficiency defined as,

$${ρ}_{i} = \{ \begin{matrix}1 & discharging \\ {η}_{i} & charging\end{matrix} . \qquad ( 44 )$$

Taking the derivative of sᵢ, gets,

$${\dot{s}}_{i} ( t ) = - \frac{{ρ}_{i}}{{q}_{i}} {I}_{i} . \qquad ( 45 )$$

But

$${I}_{i} = \frac{{σ}_{i} {p}_{i}}{{v}_{i}} ,$$

therefore,

$${\dot{s}}_{i} ( t ) = - \frac{{σ}_{i} {ρ}_{i} {p}_{i}}{{q}_{i} {v}_{i}} . \qquad ( 46 )$$

σᵢ is related to the converter efficiencies. σᵢ can be reasonably assumed 1 p.u during charging and discharging processes. The reference power generator of the i^{th} ESS can be modeled with a first-order integrator as,

$${\dot{p}}_{i} = {u}_{i} . \qquad ( 47 )$$

Therefore, the dynamic energy model of the i^{th} ESS unit can be represented as,

$${\dot{s}}_{i} ( t ) = - \frac{{σ}_{i} {ρ}_{i} {p}_{i}}{{q}_{i} {v}_{i}} , \qquad ( 48 )$$

$${\dot{p}}_{i} ( t ) = {u}_{i} .$$

Further, each battery package in the BESS in the multi-agent system 120 is subject to,

$$\begin{matrix}{s}_{i}^{min} \leq {s}_{i} ( t ) \leq {s}_{i}^{max} \\ {p}_{i}^{min} \leq {p}_{i} ( t ) \leq {p}_{i}^{max}\end{matrix} \qquad ( 49 )$$

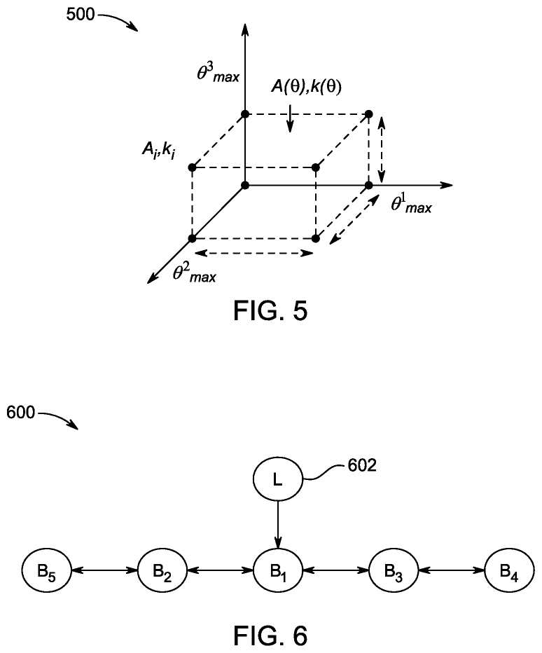

FIG. 5 illustrates a small-signal model 500 of a convex polytopic, according to certain embodiments. Polytopic representation is used to describe physical parameter uncertainty, such as uncertainty in the inertia constant and damping property of the miocrogrid. In the polytopic representation, the uncertain system belongs to a polytope which is the convex hull of the parameters of a set of models (vertices).

As more DERs are incorporated into the power grid, the inertia constant and damping property can no longer be assumed static and known. Therefore, the matrices describing the dynamics of the microgrid are transformed into uncertain models with polytopic uncertainties. That is, equation (8) becomes as follows,

$$A ( θ ) = {\sum }_{i = 1}^{N} {θ}_{i} \{ [ \begin{matrix}{A}_{i}^{n \times n} & {B}_{2 i}^{n \times r} & {B}_{1 i}^{n \times q} \\ {C}_{1 i}^{p \times n} & {D}_{12 i}^{p \times r} & {D}_{11 i}^{p \times q} \\ {C}_{2 i}^{m \times n} & {D}_{22 i}^{m \times r} & {D}_{21 i}^{m \times q}\end{matrix} ] \} \qquad ( 50 )$$

where θᵢ≥0 and Σᵢ₌₁^{N}θᵢ=1. A(θ) defines the polytopic uncertainty domain depicted pictorially in FIG. 5.

For some positive α, the uncertain system (as in equation 6) is [symbol] _{∞} in which static output feedback is robustly stable and stabilizable if there exists a positive definite matrix P̅(θ)=P̅^{T}(θ)∈ [symbol] ^{n×n} and structured matrices Z and L such that equation (51) is negative definite, given as:

$$[ \begin{matrix}α Sym ( \overline{A} ( θ ) {Z}_{i} + {\overline{B}}_{2} ( θ ) L ) & {\overline{B}}_{1} ( θ ) & α ( {Z}_{i}^{T} {\overline{C}}_{1} ( θ ) + {L}^{T} {\overline{D}}_{12}^{T} ( θ ) ) & {T}_{i} \overline{P} ( θ ) {T}_{i}^{T} + \overline{A} ( θ ) {Z}_{i} + {\overline{B}}_{2} ( θ ) L - α {Z}_{i}^{T} \\ * & - γ {I}_{m \times m} & {\overline{D}}_{11}^{T} ( θ ) & {0}_{m \times n} \\ * & * & - γ {I}_{p \times p} & {\overline{C}}_{1} ( θ ) {Z}_{i} + {\overline{D}}_{12} ( θ ) L \\ * & * & * & - ( {Z}_{i} + {Z}_{i}^{T} )\end{matrix} ] < 0. \qquad ( 51 )$$

In equation (51), P̅(θ), Zᵢ, and L reside in [symbol] and are as follows,

$$\overline{P} ( θ ) = {\sum }_{i = 1}^{N} {θ}_{i} {\overline{P}}_{i} \qquad ( 52 )$$

$$Z ( θ ) = {\sum }_{i = 1}^{N} {θ}_{i} \{ [ \begin{matrix}{Z}_{1}^{r \times r} & {0}^{r \times ( n - r )} \\ {Z}_{2 i}^{n \times ( n - r )} & {Z}_{3 i}^{( n - r ) \times ( n - r )}\end{matrix} ] \} \qquad ( 53 )$$

$$L = [ \begin{matrix}{L}_{1}^{q \times r} & {0}_{q \times ( n - r )}\end{matrix} ] \qquad ( 54 )$$

and Tᵢ denotes a nonsingular similarity transformation, composed as,

$${T}_{i} = {\sum }_{i = 1}^{N} {θ}_{i} \{ [ {C}_{2 i}^{T} ( {C}_{2 i} {C}_{2 i}^{T} ) {C}_{2 i}^{⊥} ] \} \qquad ( 55 )$$

where C₂^{⊥} is the orthogonal basis for the null space of C₂. The [symbol] _{∞} static output feedback controller that minimizes

$${‖ {G ( s )}_{w \to z} ‖}_{∞} < γ$$

and stabilizes the uncertain system can be recovered as,

$${𝓀}_{∞} = {L}_{1} {Z}_{1}^{- 1} \qquad ( 56 )$$

FIG. 6 is a communication model 600 of the multi-agent system (MAS) 120, according to certain embodiments. The distributed control 126 is a decentralized cooperative multi-agent control. As shown in FIG. 6, L denotes the leader (602) and Bᵢ denotes the i^{th} follower (i.e., BESS). The control objective of the leader-follower consensus (coordinated leader-follower multi-agent control) strategy is to simultaneously track the leader signals and synchronize the power and (SOC) among the distributed BESSs as t→∞. That is, the mandate is to have,

$$\begin{matrix}\begin{matrix}{lim}_{t \to ∞} \vert {s}_{i} ( t ) - {s}_{j} ( t ) \vert \approx 0 & ∀ i , j = 1 , 2 , ¨ n\end{matrix} \\ \begin{matrix}{lim}_{t \to ∞} \vert {p}_{i} ( t ) - {p}_{o} ( t ) \vert \approx 0 & ∀ i , j = 1 , 2 , ¨ n\end{matrix}\end{matrix} \qquad ( 57 )$$

The following control strategy is suggested for solving the consensus problem in a double-integrator leader-follower multi-agent system,

$${\dot{p}}_{i} ( t ) = {γ}_{1} [ {a}_{ir} ( {η}_{i} - {η}_{r} ) + {\sum }_{j ∈ 𝒩 i} {a}_{ij} ( {η}_{i} - {η}_{j} ) ] - {γ}_{2} [ {\sum }_{j ∈ 𝒩 i} {a}_{ij} ( {ζ}_{i} - {ζ}_{j} ) + {a}_{ir} ( {ζ}_{i} - {ζ}_{r} ] ∀ i ∈ N ] , \qquad ( 58 )$$

where ηᵢ and ζᵢ denote the multi-agent dynamics. The subscript r denotes the leader's dynamics. The leader dynamics are given as,

$$\begin{matrix}{\dot{s}}_{o} ( t ) = - \frac{{σ}_{i} {ρ}_{i}}{{q}_{i} {v}_{i}} {p}_{o} , \\ {\dot{p}}_{o} ( t ) = \frac{{k}_{o} ( {p}_{cc} - {p}_{o} )}{N} ,\end{matrix} \qquad ( 59 )$$

where p_{cc} is the command signal at the point of common coupling, and kₒ is the leader proportional gain. N denotes the total number of agents.

In the present control system 100, the virtual inertia is implemented to increase the contribution of distributed generators to oscillation damping. In an example, to emulate the inertial behavior of synchronous generators, inverter based DERs require a temporary source of energy similar to the kinetic energy of the rotor of synchronous generators. A frequency-based VSG includes a power buffer (i.e., energy storage system), power converters, and a controlling unit. During experiments, an analysis of the significance of inclusion of virtual inertia control loop on frequency control of the microgrid can be performed.

An emulated power of the inertia control loop can be described by,

$${p}_{vi} ( t ) = \frac{( {k}_{vi} \dot{f} + {k}_{d} f )}{{R}_{vi}} \qquad ( 60 )$$

where kᵥᵢ, k_{d}, and Rᵥᵢ denote the virtual inertia constant, damping coefficient, and virtual droop, respectively.

The following examples are provided to illustrate further and to facilitate the understanding of the present disclosure.

### Experimental Data and Analysis

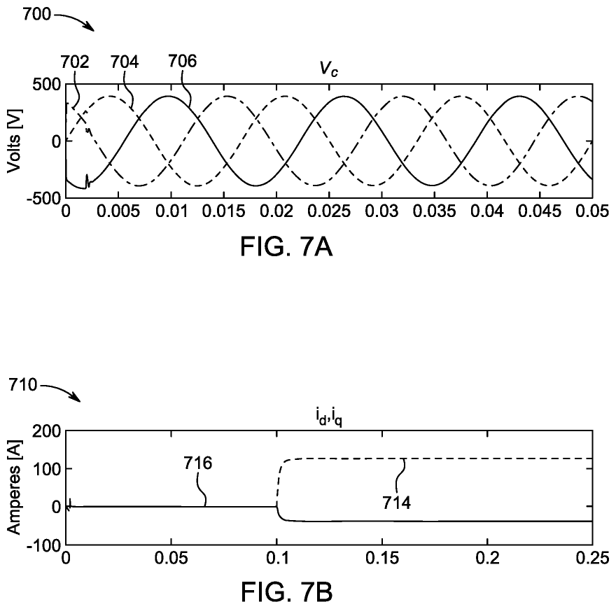

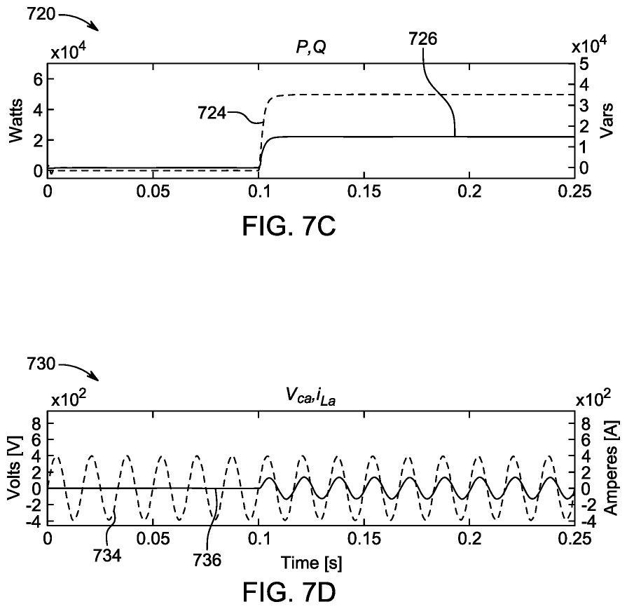

During the experiments, the simulation is initialized by verifying the performance of the small-signal model of the grid-tied inverter 122. The effectiveness of the tenth-order small-signal model in capturing the important dynamics of the grid-tied inverter 122 is demonstrated in FIG. 7A-FIG. 7D. The grid-tied inverters are coupled with the grid (i.e., pcc) through the LCL filter whose dynamics represent the inverter's output voltage and current.

FIG. 7A is a graph 700 representing the voltage waveforms of the grid-following (GFL) inverter 122 (“grid-tied inverter”). The voltage waveforms are sensed at the capacitor terminals. Signal 702 represents a leading voltage waveform. Signal 704 represents a voltage waveform. Signal 706 represents a lagging voltage waveform.

FIG. 7B is a graph 710 representing the current waveforms of the GFL inverter 122. Signal 714 represents current id generated by the dq control Signal 716 represents current iq generated by the dq control.

FIG. 7C is a graph 720 representing the power waveforms of the GFL inverter 122. Signal 724 represents a power P generated by the PQ control. Signal 726 represents a power Q generated by the PQ control. Grid-following inverters controls are designed to regulate their respective P_{ref} and Q_{ref} following global setpoints.

FIG. 7D is a graph 730 representing the voltage and current waveforms of the GFL inverter 122. Signal 734 represents a voltage v_{ca} generated by the inverter. Signal 736 represents a current i_{La} generated by the GFL inverter 122.

During experiments, the simulation are carried out on a 100 kW grid-following inverter. A simultaneous step change in P_{ref} and Q_{ref} is applied at t=0.1 s to highlight the performance of the GFL inverter 122 in tracking the setpoints, as shown in FIG. 7A-FIG. 7D. FIG. 7A and FIG. 7C, depict the inductor dq current and inverter voltage waveforms while tracking the reference currents. As seen in FIG. 7A-FIG. 7D, the GFL inverter 122. quickly picks up the commanded setpoints without significant overshoots.

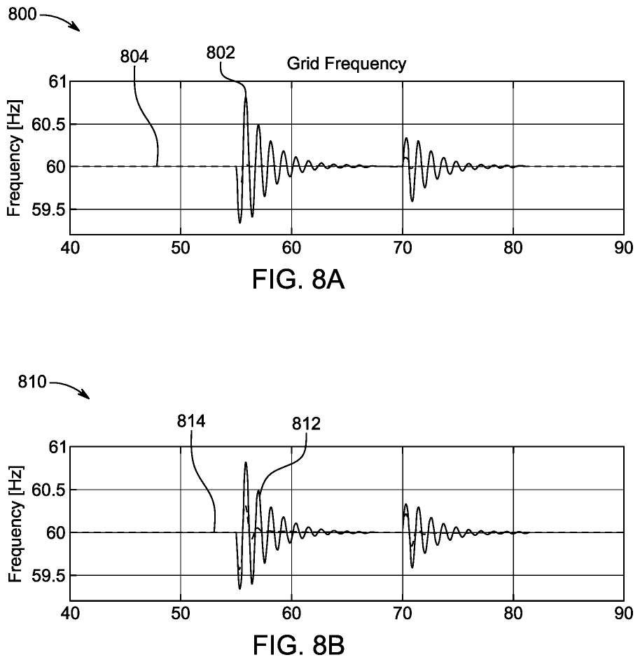

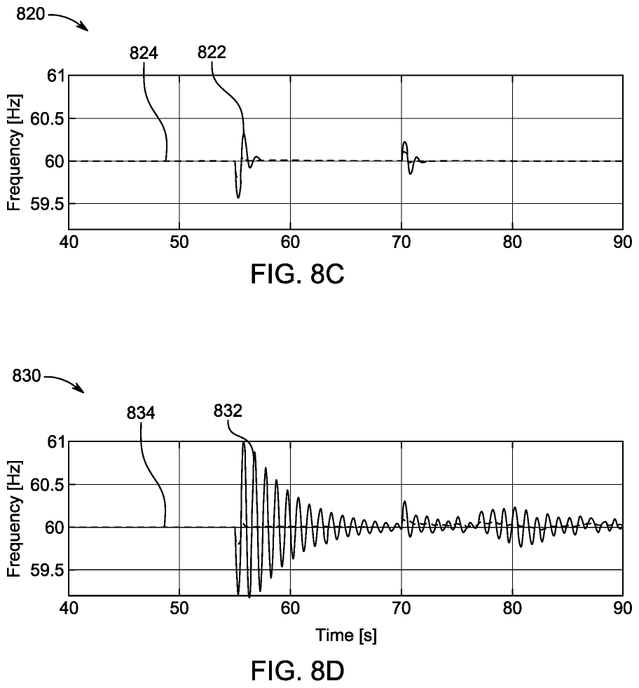

FIG. 8A-FIG. 8D represent a frequency response of the microgrid 108 having the present control system 100 in comparison with the microgrid having a conventional PI control.

In FIG. 8A-FIG. 8D, the efficacy of the [symbol] _{∞} based virtual inertia control is tested against sudden load disruptions and various RESs injections. The controller's performance was also compared with the conventional PI controller, highlighting its robustness at different inertia levels. The simulations can be carried out assuming that the islanded microgrid is isolated from the utility grid 102 and is formed by the synchronous generator. The islanded microgrid 108, shown in FIG. 1, is used to validate the control design.

The coordinated [symbol] _{∞} cooperative virtual control strategy provides an optimum performance for the uncertain microgrid over the convex polytope, depicted in FIG. 5. The inertia constant (H_{μG}) and the damping property (D_{μG}) are deemed unknown beforehand but have lower and upper bounds. Note that the lower and upper bounds of H_{μG} and D_{μG} characterize the vertices of the polytopic system. This assumption can be reasonably justified since both H_{μG} and D_{μG} vary over the day according to the committed and de-committed machines.

FIG. 8A is an exemplary comparison graph 800 representing the frequency response of the microgrid 108 when no control system is used versus the centralized [symbol] _{∞} controller 116 is used respectively. Signal 802 represents the frequency response of the microgrid when no control is used. Signal 804 represents the frequency response of the microgrid when the centralized [symbol] _{∞} controller 116 is used.

FIG. 8B is another exemplary comparison graph 810 representing the frequency response of the microgrid. Signal 812 represents the frequency response of the microgrid 108 when no control system is used. Signal 814 represents the frequency response of the microgrid 108 when a conventional proportional integral (PI) controller is used.

FIG. 8C is another exemplary comparison graph 820 representing the frequency response of the microgrid. Signal 822 represents the frequency response of the microgrid 108 when the conventional PI controller is used. Signal 824 represents the frequency response of the microgrid 108 when the present control system 100 (the centralized [symbol] _{∞} controller 116) is used.

FIG. 8D is another exemplary comparison graph 830 representing the frequency response of the microgrid 108 when no control system is used versus the centralized [symbol] _{∞} controller 116 is used respectively. Signal 832 represents the frequency response of the microgrid 108 when no control is used. Signal 834 represents the frequency response of the microgrid 108 when the present control system 100 (the centralized [symbol] _{∞} controller 116) is used.

In FIG. 8A-FIG. 8D, the islanded microgrid 108 is tested using different operating conditions and scenarios. To demonstrate the robustness of the [symbol] _{∞} controller 116, the islanded microgrid 108 is examined at 40% (medium) and [15˜20%] (low) of the nominal microgrid parameters (H_{μG}, D_{μG}). At 40% of the nominal system inertia, a 5% step change is applied at t=55 s and t=70 s, representing a connection of a composite load or a loss of a generating unit and a connection of RES, respectively. The frequency response of the islanded microgrid is analyzed in FIG. 8A with and without the [symbol] _{∞} based virtual inertia unit. It is clear from the FIG. 8A-FIG. 8D that the frequency response of the microgrid 108 without inertial support experiences destabilizing oscillations and higher ROCOF values. On the contrary, under the present control system 100, the frequency response has a minimal overshoot and settling time, highlighting the robustness of the [symbol] _{∞} controller. FIG. 8B and FIG. 8C depict the [symbol] _{∞} controller 116 outperforming the conventional PI controller in minimizing the ROCOF by regulating the microgrid frequency. The efficacy of the control system 100 is also examined under severe operating conditions in FIG. 8D. A highly noisy signal is injected into the system 100 at 20% of the nominal system inertia, resembling a high penetration of RES. The frequency profile under such severe disturbances highlights the performance of the [symbol] _{∞} control. It also shows that the [symbol] _{∞} control provides robust and optimal performance under extreme disruptions.

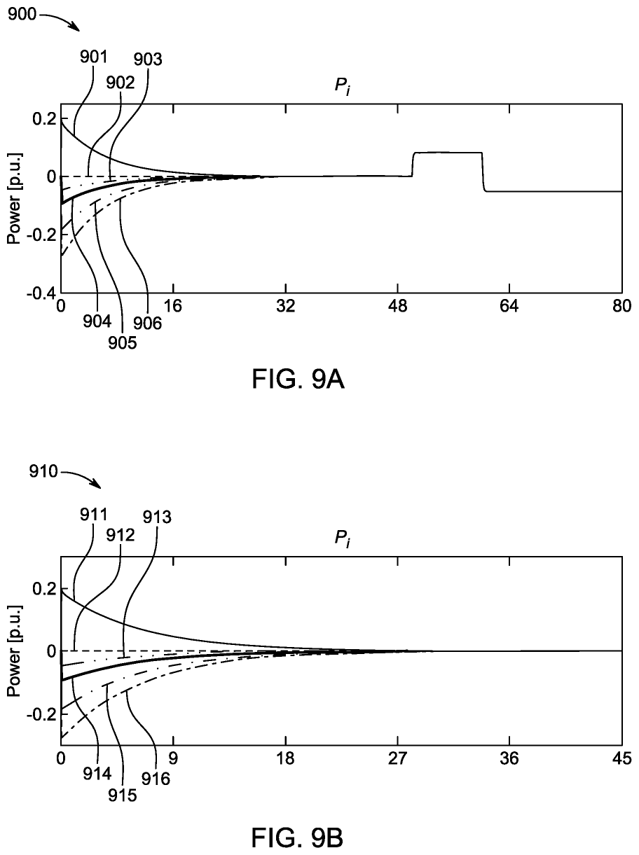

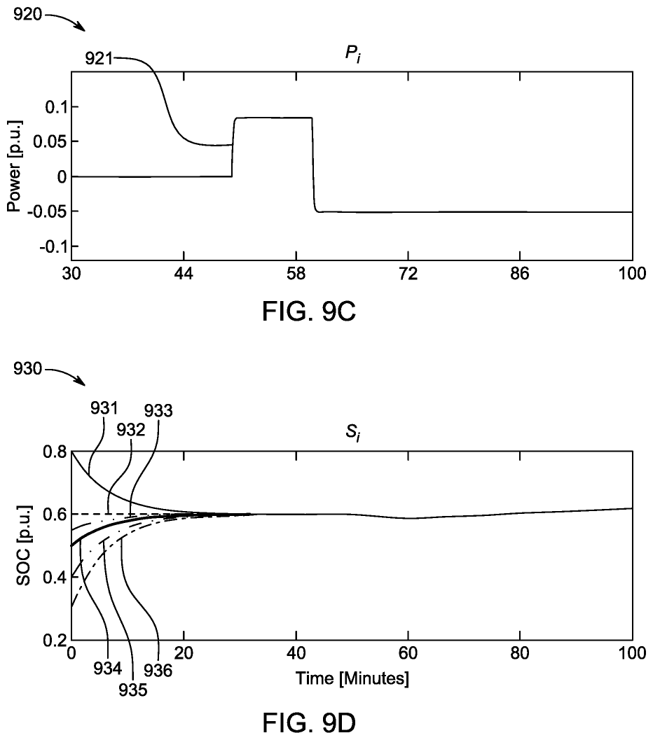

FIG. 9A-FIG. 9D represent dynamic analysis of the MAS 120. In an example, the MAS 120 includes a 1.5 MW inverter and a group of lithium-ion batteries. Each battery has a capacity of 225 kWh. Each battery is assumed to be capable of delivering a maximum power of 1.5 C-rating of its capacity, as lithium-ion batteries designed for frequency regulation can be discharged and charged rapidly. For simulation purposes, a MAS including six Li-ion batteries is considered. The communication topology of the MAS is depicted in FIG. 6. The BESSs, which are part of the cooperative control design, are assumed to be having a sparse communication link that provides a neighbor to neighbor communication. The leader, denoted as L, is directly connected to the first follower, while the remaining followers have no access to the leader. To demonstrate the operation of the cooperative control system 100 and avoid significant lifetime deterioration, the simulation of the batteries between 45 kWh and 180 kWh (20˜80%) of their dynamic SOCs is initialized.

FIG. 9A is an exemplary graph 900 representing the dynamic analysis of the MAS 120 over a time period of 0 to 80 minutes. Signal 901 represents response of an agent 4 (B₄). Signal 902 represents response of an agent L (leader). Signal 903 represents response of an agent 1 (B₁). Signal 904 represents response of an agent 5 (B₅). Signal 905 represents response of an agent 2 (B₂). Signal 906 represents response of an agent 3 (B₃).

FIG. 9B is an exemplary graph 910 representing the dynamic analysis of the MAS 120 over a time period of 0 to 45 minutes. Signal 911 represents response of an agent 4 (B₄). Signal 912 represents response of an agent L (leader). Signal 913 represents response of an agent 1 (B₁). Signal 914 represents response of an agent 5 (B₅). Signal 915 represents response of an agent 2 (B₂). Signal 916 represents response of an agent 3 (B₃).

FIG. 9C is an exemplary graph 920 representing the dynamic analysis of the MAS 120 over a time period of 30 to 100 minutes. Signal 921 represents response of the present control system 100.

FIG. 9D is an exemplary graph 930 representing the SOCs of the batteries connected with the MAS 120 over a time period of 0 to 100 minutes. Signal 931 represents SOC of an agent 4 (B₄). Signal 932 represents SOC of an agent L (leader). Signal 933 represents SOC of an agent 1 (B₁). Signal 934 represents SOC of an agent 5 (B₅). Signal 935 represents SOC of an agent 2 (B₂). Signal 936 represents SOC of an agent 3 (B₃).

Although the BESSs have no initial power at initialization, the units have to exchange the power to equalize the SOCs, satisfying the consensus protocol as depicted in FIG. 9A-FIG. 9D. FIG. 9A-FIG. 9D showcase the cooperative controller's effectiveness in synchronizing the multi-agent system's dynamic performance when step changes are applied at t=50 Min and t=60 Min, representing active power setpoints commanded by the system operator. After achieving consensus mode in power and energy, the batteries quickly pick up the signal and follow the leader discharging and charging powers.

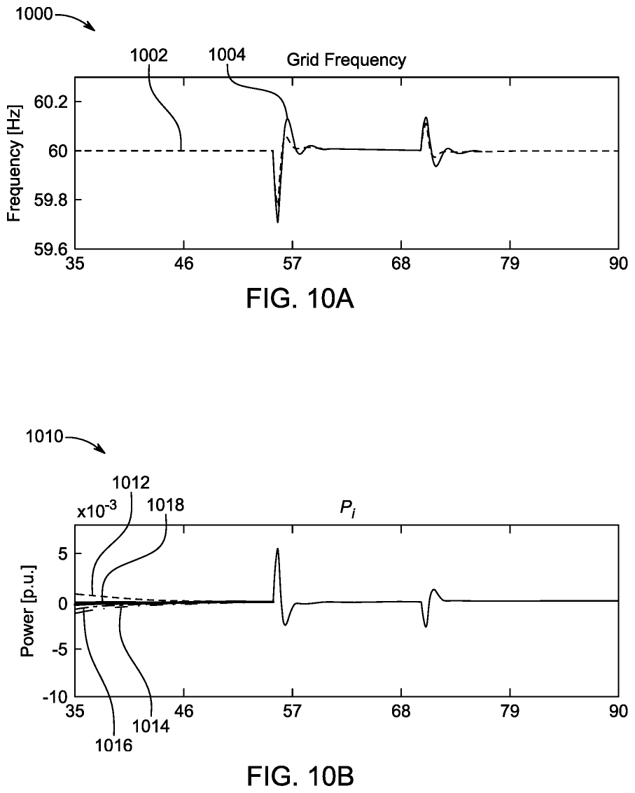

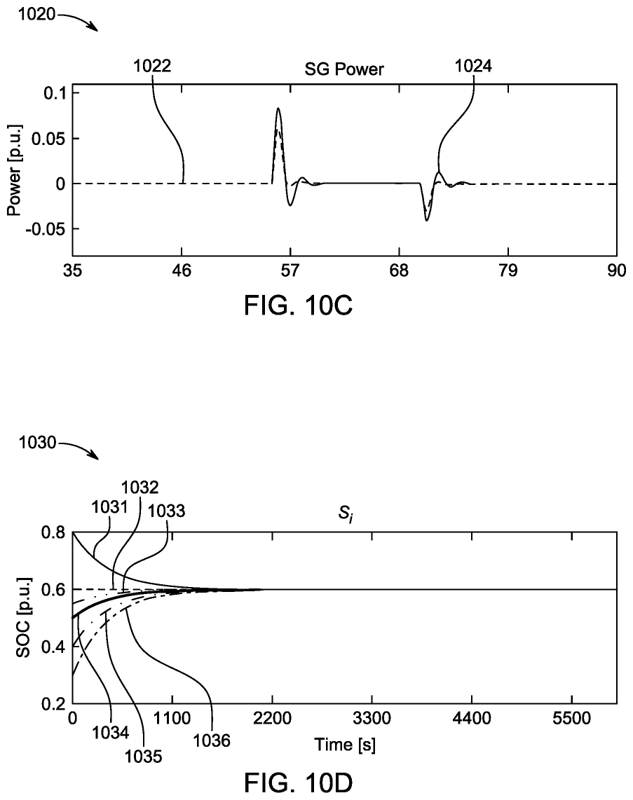

FIG. 10A is an exemplary graph 1000 representing the grid frequency of the microgrid 108 having the control system 100 over a time period of 35 to 90 minutes. Signal 1002 represents the grid frequency when the control system 100 is implemented with the virtual inertia support. Signal 1004 represents the grid frequency when the control system 100 is implemented without the virtual inertia support is implemented.

FIG. 10B is an exemplary graph 1010 representing the dynamic analysis of the MAS 120 having the virtual inertia support over a time period of 35 to 90 minutes corresponding to the grid frequency. Signal 1012 represents response of an agent L. Signal 1014 represents response of an agent 2 (B₂). Signal 1016 represents response of an agent 3 (B₃). Signal 1018 represents response of the agent 4 (B₄) and agent 5 (B₅).

FIG. 10C is an exemplary graph 1020 representing the dynamic analysis of the synchronous generator (SG) power over a time period of 35 to 90 minutes. Signal 1022 represents the SG power when the control system 100 is implemented with the virtual inertia support. Signal 1024 represent the SG power when the control system 100 is implemented without the virtual inertia support is implemented.

FIG. 10D is an exemplary graph 1030 representing the SOCs of the batteries connected with the MAS 120. Signal 1031 represents SOC of an agent 4 (B₄). Signal 1032 represents SOC of an agent L. Signal 1033 represents SOC of an agent 1 (B₁). Signal 1034 represents SOC of an agent 5 (B₅). Signal 1035 represents SOC of an agent 2 (B₂). Signal 1036 represents SOC of an agent 3 (B₃).

The microgrid is examined at H_{μG}=0.0332 s and D_{μG}=0.0064. FIG. 10A-FIG. 10D depict the response of the system 100 with and without the virtual inertia support. Step changes are applied at t=55 s and t=70 s, representing an increment in the load and a connection of a RES unit, respectively. It is seen from FIG. 10A-FIG. 10D that the microgrid frequency response without inertial support undergoes larger rate of change of frequency (ROCOF) values, resulting in a longer stabilizing time. The situation may even worsen as inertia levels decrease. In such scenario (i.e., FIG. 10B and FIG. 10D), the MAS has reached a steady state mode (i.e., consensus mode) and is ready to pick up part of the generator's effort.

The synchronous machine's response with and without the cooperative control is shown in FIG. 10C. When the cooperative controller (centralized [symbol] _{∞} controller 116) is integrated, the generator produces lesser effort to sustain the disturbances. The multi-agent system 120 relieves the generator by supplying or absorbing the deficit power during the disturbances. The cooperative control provides an energy consensus among the batteries while tracking the active power setpoint and reactive power setpoint of the PCC. The setpoints are generated by the centralized [symbol] _{∞} controller 116.

The performance of the present control system 100 (having [symbol] _{∞} based VSG) is compared with the conventional controlling system (PI-based VSG) and is summarized in Table 1. It is observed from the table 1 that the present control system 100 is efficient in comparison to conventional controlling systems. Table 1 illustrates a performance metrics of the microgrid at 40% of [H_{μG}, D_{μG}]. In table 1, a comparison is carried out in terms of maximum undershoot (MUS), maximum overshoot (MOS), frequency Nadir (f_{Nadir}), and settling time (Tₛ). It is seen that the present control system 100 outperforms the PI-based VSG in terms the MUS, MOS, Tₛ, and the frequency Nadir, demonstrating the robustness of the present control system 100.

TABLE 1
Summary of performance comparison

| VSG Model | MUS | MOS | f_{Nadir} | Tₛ | γ |
|---|---|---|---|---|---|
| No control | 0.67 | 0.83 | 59.34 | 8.952 | — |
| Conventional controlling system | 0.35 | 0.19 | 59.65 | 3.711 | — |
| (PI-based VSG) | | | | | |
| The present control system 100 | 0.2 | 0.005 | 59.8 | 1.723 | 1.7152 |

During experiments, a step increase in load is translated into a discharging signal to the microgrid's BESSs. This command signal (discharging signal) is received by the virtual leader L and is distributed among the followers through the pinning agent (the agent connected with the leader directly). Under a large share of RESs, the system's frequency experiences higher ROCOF values. Regulating the frequency without integrating the virtual inertia requires load-shedding initiation to prevent the system from a catastrophic collapse. Therefore, the integration of virtual inertia successfully maintains the ROCOF values within the permissible bounds.

The islanded microgrid 108, shown in FIG. 1, is extensively constructed in the RTDS simulator (developed by RTDS Technologies Inc., located at 150 Innovation Drive Winnipeg, MB R3T 2E1, Canada) to validate the present control system 100. In an aspect, RTDS simulator is the proprietary simulation software package that is used to configure the simulations that are then run on parallel processing hardware. The power injections from the wind, PV, EV charger, and the composite load are treated as disturbances to the control system 100. A real-time simulation is performed in the runtime environment using the same operating conditions to verify the small-signal models and validate the control design. The runtime environment in the RTDS does not allow stacking up multiple graphs in the same window. Therefore, the results are discussed independently. Compiling the load flow analyses in the RTDS is vital to initialize the initial conditions and reduce the transients in the runtime. However, this process does not always guarantee smooth startups. Therefore, the synchronous generator is initialized in a lock mode at the startup to reduce the transients. Once the steady state is reached, the generator is released, in which the AGC becomes active and eliminates the steady state errors. The units are energized sequentially to examine the ability of the cooperative controller 116 to provide inertia emulation and balance the dynamic SOC of the distributed BESSs.

To demonstrate the effectiveness of the disclosed controllers (associated with each of DERs), the following tests have been applied.

(A) dynamic performance of the microgrid with no inertial support

(B) inertial power command generated by the centralized [symbol] _{∞} controller 116

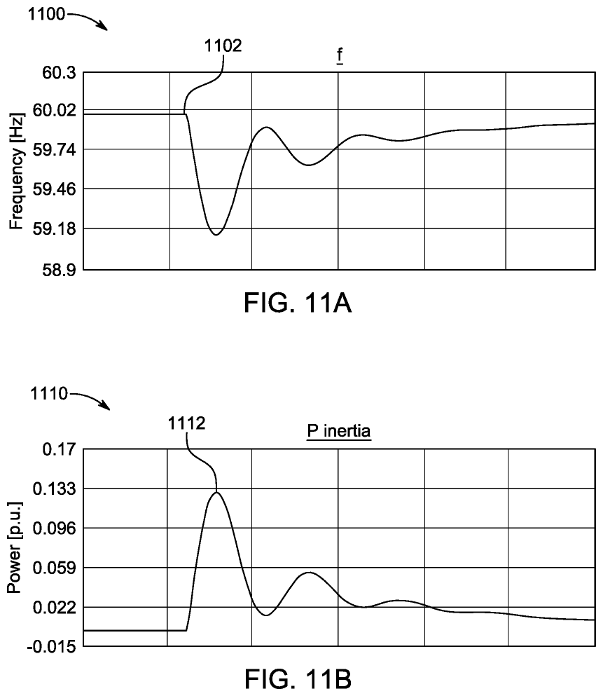

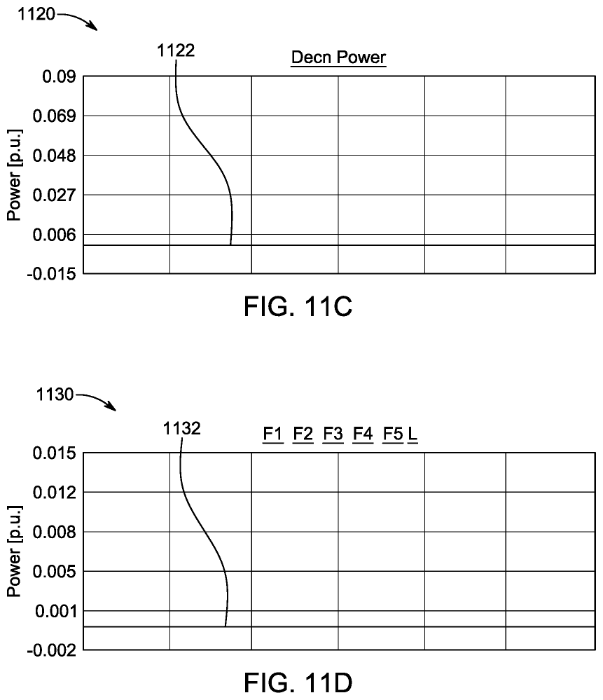

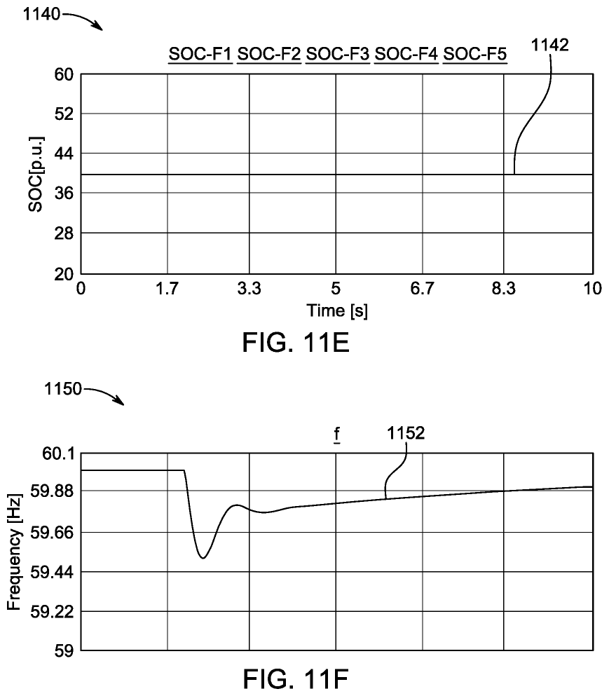

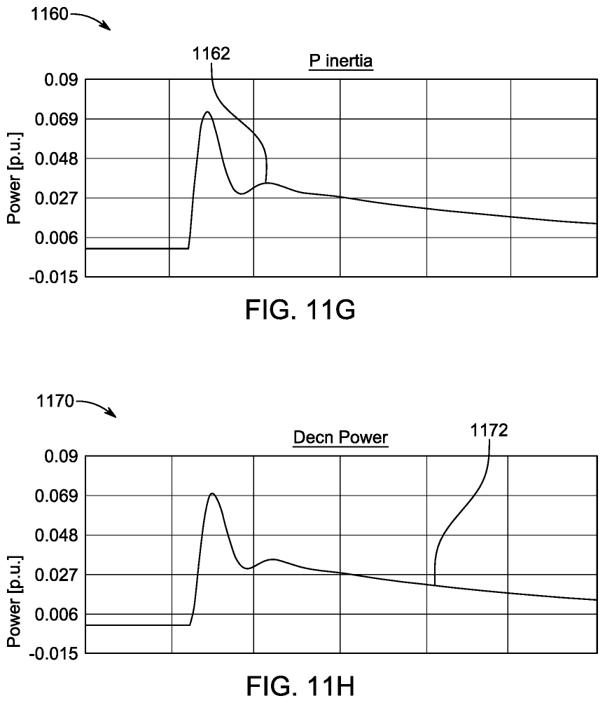

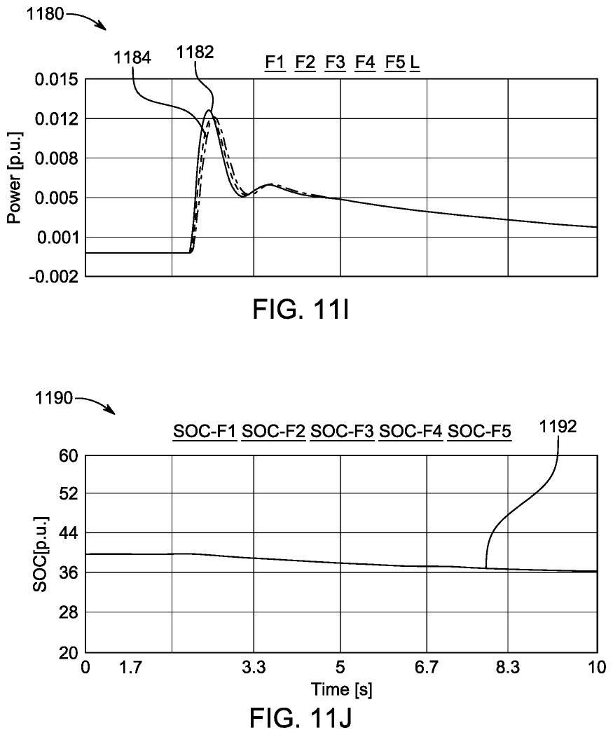

FIG. 11A-FIG. 11J represent the dynamic analysis of the islanded microgrid in RTDS runtime environment. FIG. 11A-FIG. 11E represent the frequency response of the microgrid due to a step in the demand (15%). FIG. 11F-FIG. 11J represent the MAS discharging powers under the coordinated [symbol] _{∞} cooperative control as disclosed in the present disclosure.

FIG. 11A-FIG. 11E depict the system response after a sudden disruption in the load when the virtual inertia loop is integrated. FIG. 11A-FIG. 11E represent the frequency response of the microgrid due to a step in the demand (15%). FIG. 11A is an exemplary graph 1100 representing the frequency of the microgrid due to sudden disruption in the load (a 15% increment of demand). Signal 1102 represents a frequency response of the microgrid.

FIG. 11B is an exemplary graph 1110 representing the power of the microgrid due to sudden disruption in the load. Signal 1112 represents a power response of the microgrid.

FIG. 11C is an exemplary graph 1120 representing the decaying power of the microgrid due to sudden disruption in the load. Signal 1122 represents a decaying power response of the microgrid.

FIG. 11D is an exemplary graph 1130 representing the power of the MAS due to sudden disruption in the load. Signal 1132 represents a power response of the MAS.

FIG. 11E is an exemplary graph 1140 representing the SOCs of the MAS due to sudden disruption in the load. Signal 1142 represents a SOCs response of the MAS.

FIG. 11F is an exemplary graph 1150 representing the frequency of the microgrid connected to the centralized [symbol] _{∞} controller 116 due to sudden disruption in the load. Signal 1152 represents a frequency response of the microgrid.

FIG. 11G is an exemplary graph 1160 representing the power of the microgrid connected to the centralized [symbol] _{∞} controller 116 due to sudden disruption in the load. Signal 1162 represents a power response of the microgrid.

FIG. 11H is an exemplary graph 1170 representing the decaying power of the microgrid connected to the centralized [symbol] _{∞} controller 116 due to sudden disruption in the load. Signal 1172 represents a decaying power response of the microgrid.

FIG. 11I is an exemplary graph 1180 representing the power of the MAS 120 connected to the centralized [symbol] _{∞} controller 116 due to sudden disruption in the load. Signal 1182 represents a power response of the leader. Signal 1184 represents a power response of other agents in MAS 120.

FIG. 11J is an exemplary graph 1190 representing the SOCs of the MAS 120 connected to the centralized [symbol] _{∞} controller 116 due to sudden disruption in the load. Signal 1192 represents a SOCs response of the MAS 120.

The microgrid is tested at 80% of the nominal system inertia. FIG. 11A-FIG. 11E depict the system response after a sudden disruption in the load when the virtual inertia loop is integrated. FIG. 11A-FIG. 11E demonstrate the dynamic performance of the microgrid with no inertial support, while FIG. 11F-FIG. 11J emphasize the inertial power command generated by the centralized [symbol] _{∞} controller. In this mode, the virtual inertia unit receives the setpoints, but the circuit breaker is not closed yet. In FIG. 11F-FIG. 11J, the performance of the coordinated control design is examined. In this scenario, the circuit breaker of the virtual inertia unit is active and quickly picks up the requested inertial power, aiming to limit the frequency deviation and stabilize the grid. The robustness of the proposed coordinated [symbol] _{∞} cooperative control design is demonstrated in FIG. 11F-FIG. 11J. In both scenarios, the multi-agent system 120 acts as an energy buffer and picks up part of the load, emulating the generator response after grid disruptions. The batteries effectively charge and discharge their powers in a consensus fashion after reaching steady state mode, as shown in FIG. 11A-FIG. 11J. The batteries collaboratively regulate the frequency, satisfying the cooperative controller. Such preliminary results verify that the proposed control scheme can be applied to a realistic system and achieve the control objectives. It is clear from FIG. 11A-FIG. 11J that integrating the virtual inertia loop helps to arrest the Rate of Change of Frequency (ROCOF) values and minimizes the frequency nadir (i.e., the minimum frequency value attained during the transient period).

Reiterating, the control system 100 has at least following features:
1. providing a centralized robust [symbol] _{∞} static output feedback and a decentralized cooperative multi-agent control as a control strategy to regulate the frequency of the islanded microgrid and synchronize the power and SOCs among the operative batteries, emulating the inertial response of synchronous generators.
2. constructing small-signal models to capture the dynamic interaction between the microgrid components.
3. considering the inertia constant (H_{μG}) and the damping property (D_{μG}) that are uncertain but bounded. The small-signal models are transformed into uncertain models over a convex polytope parameterized by H_{μG} and D_{μG}.

The present disclosure describes a coordinated [symbol] _{∞} leader-follower multi-agent control approach to achieve two objectives. That is, to regulate the frequency of islanded microgrids having low inertia levels and balance the SOC of microgrid storage systems, acting as a grid-forming unit. Lyapunov theories and linear matrix inequalities have been utilized to transform the system's dynamics into an uncertain polytopic model. In this study, the microgrid's inertia constant and damping properties have been considered unknown but bounded. Sufficient dilated [symbol] _{∞} conditions have been used to construct the controller 116 and convexify the optimization problem. The secondary control objective has been achieved using a cooperative controller 116 that adjusts the output power of the operative batteries to balance the SOC while providing inertial support to the microgrid, emulating the inertial response of the synchronous generator. [symbol] _{∞} control design does not require a continuous online process compared to model predictive control and adaptive control, making it highly practical and suitable for various applications. The cooperative controller 116 ensures that no battery is depleted when available capacity exists in the remaining ESSs, offering advantages over centralized control strategies in terms of optimality and utilization. Using the RTDS, real-time analyses have been completed demonstrating the efficacy and robustness of the coordinated control design at different inertia levels and under various RESs injections.

An embodiment is illustrated with respect to FIG. 1 to FIG. 2. The embodiment describes a control system 100 to regulate frequency of an islanded microgrid 108, having at least one grid-tied renewable energy source. The control system 100 includes a centralized [symbol] _{∞} controller 116, a multi-agent system 120, and a distributed control 126. The centralized [symbol] _{∞} controller 116 generates active and reactive power setpoints. The multi-agent system 120 is integrated into the grid through a grid-tied inverter 122 coupled with an LCL filter. The distributed control 126controls the multi-agent system 120 and the grid-tied inverter 122 to adjust output power of a multi-agent microgrid storage 128 cooperatively so that they achieve consensus in the energy while providing inertial support.

In an aspect, the renewable energy source is the PV system 110.

In an aspect, the renewable energy source is the wind turbine system 112.

In an aspect, the centralized [symbol] _{∞} controller 116 regulates the frequency of an islanded microgrid 108.

In an aspect, the centralized [symbol] _{∞} controller 116 outputs feedback that minimizes the maximum gain of the output over disturbances.

In an aspect, the disturbances include power injections from the at least one grid-tied renewable energy source.

In an aspect, the system includes a virtual inertial unit that receives the active and reactive power setpoints and enhances the centralized [symbol] _{∞} controller 116 to exhibit damping and inertia properties of a synchronous generator.

In an aspect, the microgrid dynamics are transformed into uncertain convex polytopic small-signal models using Lyapunov theories and linear matrix inequalities. A convex optimization model is solved to allocate the centralized [symbol] _{∞} controller 116 that stabilizes the microgrid over the uncertain convex polytope.

In an aspect, the multi-agent system 120 includes a group of battery energy storage devices. The distributed control 126 is a decentralized cooperative multi-agent control to synchronize the power and state of charge (SOCs) among the battery energy storage devices.

In an aspect, the multi-agent control operates according to a coordinated leader-follower multi-agent control strategy configured to balance the state of charge (SOC) of the battery energy storage devices, by adjusting output power of operative batteries to balance the SOC while providing inertial support to the microgrid, while ensuring that no battery is depleted when available capacity exists in the remaining battery energy storage devices.

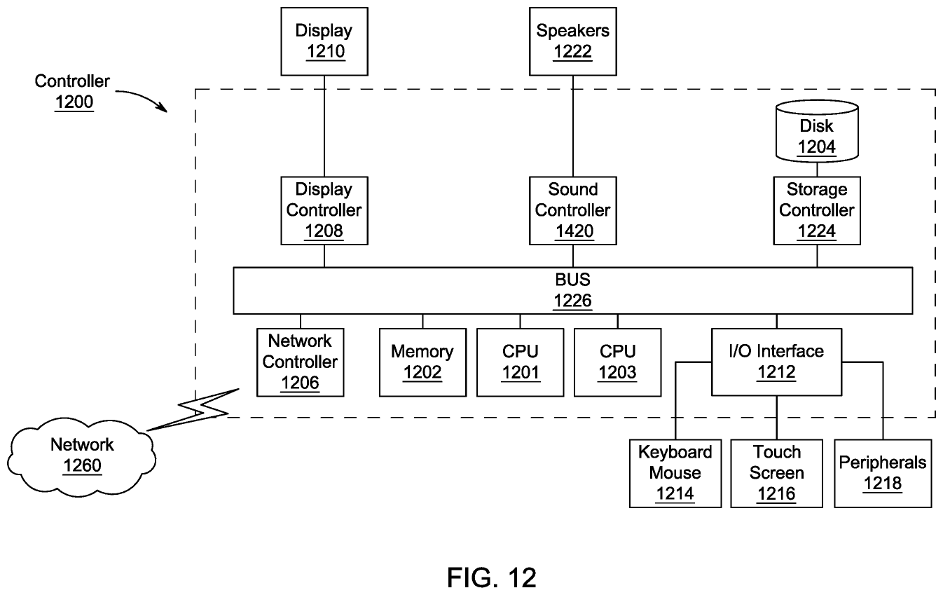

Next, further details of the hardware description of the computing environment of FIG. 1, according to exemplary embodiments is described with reference to FIG. 12. In FIG. 12, a controller 1200 is described is representative of the control system 100 of FIG. 1 in which the centralized [symbol] _{∞} controller 116 is a computing device which includes a CPU 1201 which performs the processes described above/below. The process data and instructions may be stored in memory 1202. These processes and instructions may also be stored on a storage medium disk 1204 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 1201, 1203 and an operating system such as Microsoft Windows 7, Microsoft Windows 10, UNIX, Solaris, LINUX, Apple MAC-OS and other systems known to those skilled in the art.

The hardware elements in order to achieve the computing device may be realized by various circuitry elements, known to those skilled in the art. For example, CPU 1201 or CPU 1203 may be a Xenon or Core processor from Intel of America or an Opteron processor from AMD of America, or may be other processor types that would be recognized by one of ordinary skill in the art. Alternatively, the CPU 1201, 1203 may be implemented on an FPGA, ASIC, PLD or using discrete logic circuits, as one of ordinary skill in the art would recognize. Further, CPU 1201, 1203 may be implemented as multiple processors cooperatively working in parallel to perform the instructions of the inventive processes described above.

The computing device in FIG. 12 also includes a network controller 1206, such as an Intel Ethernet PRO network interface card from Intel Corporation of America, for interfacing with network 1260. As can be appreciated, the network 1260 can be a public network, such as the Internet, or a private network such as an LAN or WAN network, or any combination thereof and can also include PSTN or ISDN sub-networks. The network 1260 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 1208, such as a NVIDIA Geforce GTX or Quadro graphics adaptor from NVIDIA Corporation of America for interfacing with display 1210, such as a Hewlett Packard HPL2445w LCD monitor. A general purpose I/O interface 1212 interfaces with a keyboard and/or mouse 1214 as well as a touch screen panel 1216 on or separate from display 1210. General purpose I/O interface also connects to a variety of peripherals 1218 including printers and scanners, such as an OfficeJet or DeskJet from Hewlett Packard.

A sound controller 1220 is also provided in the computing device such as Sound Blaster X-Fi Titanium from Creative, to interface with speakers/microphone 1222 thereby providing sounds and/or music.

The general purpose storage controller 1224 connects the storage medium disk 1204 with communication bus 1226, which may be an ISA, EISA, VESA, PCI, or similar, for interconnecting all of the components of the computing device. A description of the general features and functionality of the display 1210, keyboard and/or mouse 1214, as well as the display controller 1208, storage controller 1224, network controller 1206, sound controller 1220, and general purpose I/O interface 1212 is omitted herein for brevity as these features are known.

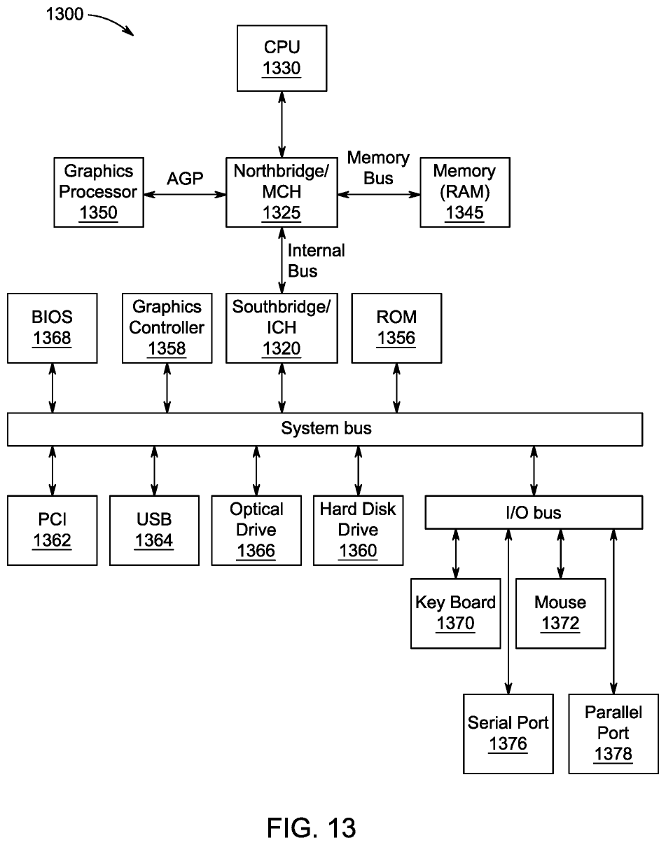

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 13.

FIG. 13 shows a schematic diagram of a data processing system, according to certain embodiments, for performing the functions of the exemplary embodiments. The data processing system is an example of a computer in which code or instructions implementing the processes of the illustrative embodiments may be located.

In FIG. 13, data processing system 1300 employs a hub architecture including a north bridge and memory controller hub (NB/MCH) 1325 and a south bridge and input/output (I/O) controller hub (SB/ICH) 1320. The central processing unit (CPU) 1330 is connected to NB/MCH 1325. The NB/MCH 1325 also connects to the memory 1345 via a memory bus, and connects to the graphics processor 1350 via an accelerated graphics port (AGP). The NB/MCH 1325 also connects to the SB/ICH 1320 via an internal bus (e.g., a unified media interface or a direct media interface). The CPU Processing unit 1330 may contain one or more processors and even may be implemented using one or more heterogeneous processor systems.

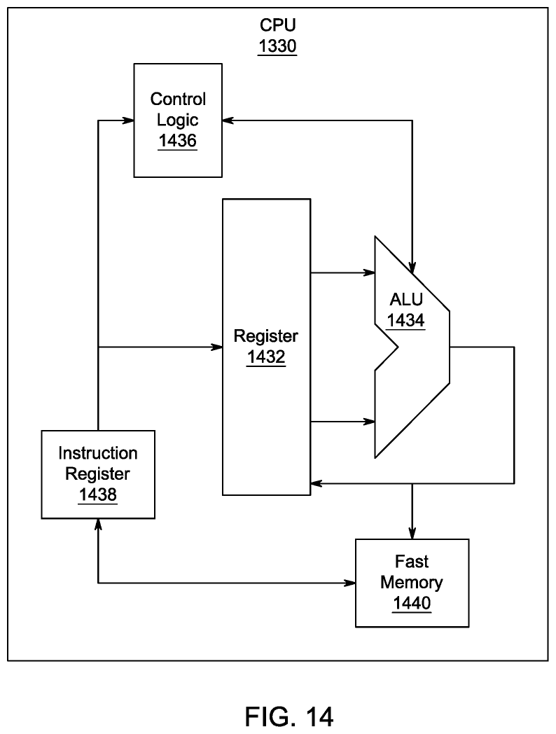

For example, FIG. 14 shows one implementation of CPU 1330. In one implementation, the instruction register 1438 retrieves instructions from the fast memory 1440. At least part of these instructions are fetched from the instruction register 1438 by the control logic 1436 and interpreted according to the instruction set architecture of the CPU 1430. Part of the instructions can also be directed to the register 1432. In one implementation the instructions are decoded according to a hardwired method, and in another implementation the instructions are decoded according to a microprogram that translates instructions into sets of CPU configuration signals that are applied sequentially over multiple clock pulses. After fetching and decoding the instructions, the instructions are executed using the arithmetic logic unit (ALU) 1434 that loads values from the register 1432 and performs logical and mathematical operations on the loaded values according to the instructions. The results from these operations can be feedback into the register and/or stored in the fast memory 1440. According to certain implementations, the instruction set architecture of the CPU 1330 can use a reduced instruction set architecture, a complex instruction set architecture, a vector processor architecture, a very large instruction word architecture. Furthermore, the CPU 1330 can be based on the Von Neuman model or the Harvard model. The CPU 1330 can be a digital signal processor, an FPGA, an ASIC, a PLA, a PLD, or a CPLD. Further, the CPU 1330 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 13, the data processing system 1300 can include that the SB/ICH 1320 is coupled through a system bus to an I/O Bus, a read only memory (ROM) 1356, universal serial bus (USB) port 1364, a flash binary input/output system (BIOS) 1368, and a graphics controller 1358. PCI/PCIe devices can also be coupled to SB/ICH 1388 through a PCI bus 1362.

The PCI devices may include, for example, Ethernet adapters, add-in cards, and PC cards for notebook computers. The Hard disk drive 1360 and CD-ROM 1366 can use, for example, an integrated drive electronics (IDE) or serial advanced technology attachment (SATA) interface. In one implementation the I/O bus can include a super I/O (SIO) device.

Further, the hard disk drive (HDD) 1360 and optical drive 1366 can also be coupled to the SB/ICH 1320 through a system bus. In one implementation, a keyboard 1370, a mouse 1372, a parallel port 1378, and a serial port 1376 can be connected to the system bus through the I/O bus. Other peripherals and devices that can be connected to the SB/ICH 1320 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

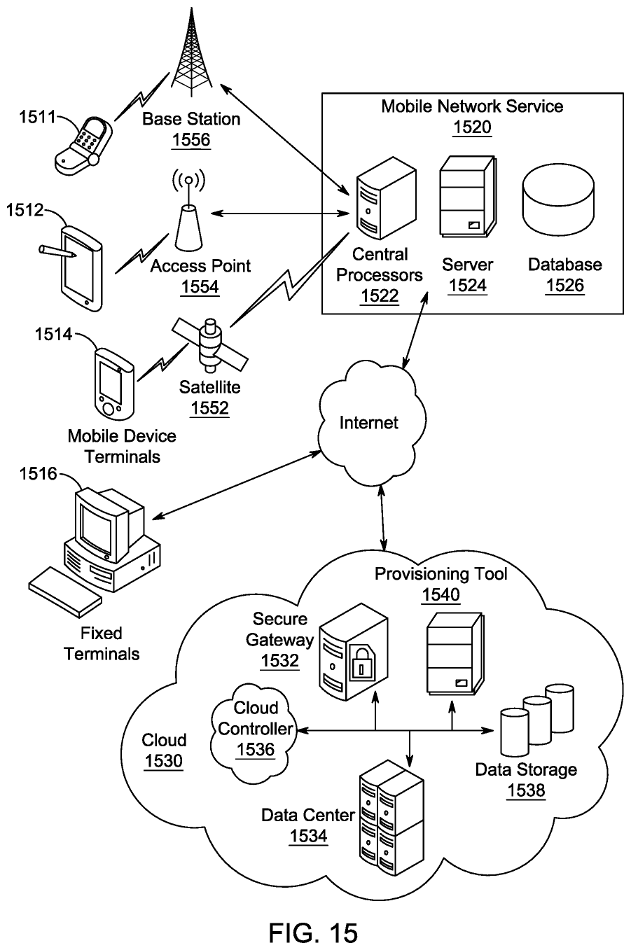

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 15, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

More specifically, FIG. 15 illustrates client devices including smart phone 1511, tablet 1512, mobile device terminal 1514 and fixed terminals 1516. These client devices may be commutatively coupled with a mobile network service 1520 via base station 1556, access point 1554, satellite 1552 or via an internet connection. Mobile network service 1520 may comprise central processors 1522, server 1524 and database 1526. Fixed terminals 1516 and mobile network service 1520 may be commutatively coupled via an internet connection to functions in cloud 1530 that may comprise security gateway 1532, data center 1534, cloud controller 1536, data storage 1538 and provisioning tool 1540.

The above-described hardware description is a non-limiting example of corresponding structure for performing the functionality described herein. The above-described hardware description is a non-limiting example of corresponding structure for performing the functionality described herein.

Numerous modifications and variations of the present disclosure are possible in light of the above teachings. It is therefore to be understood that the invention may be practiced otherwise than as specifically described herein.

1. A control system to regulate frequency of an islanded microgrid, having at least one grid-tied renewable energy source, comprising:
a centralized [symbol] _{∞} controller to generate active and reactive power setpoints;
a multi-agent system integrated into the grid through a grid-tied inverter coupled with an LCL filter; and
a distributed control to control the multi-agent system and the grid-tied inverter to adjust output power of a multi-agent microgrid storage cooperatively so that they achieve consensus in the energy while providing inertial support.

2. The control system of claim 1, wherein the renewable energy source is a photovoltaic (PV) system.

3. The control system of claim 1, wherein the renewable energy source is a wind turbine system.

4. The control system of claim 1, wherein the centralized [symbol] _{∞} controller regulates the frequency of an islanded microgrid.

5. The control system of claim 1, wherein the centralized [symbol] _{∞} controller outputs feedback that minimizes the maximum gain of the output over disturbances.

6. The control system of claim 5, wherein the disturbances include power injections from the at least one grid-tied renewable energy source.

7. The control system of claim 1, further comprising a virtual inertial unit that receives the active and reactive power setpoints and enhances the centralized [symbol] _{∞} controller to exhibit damping and inertia properties of a synchronous generator.

8. The control system of claim 1, wherein microgrid dynamics are transformed into uncertain convex polytopic small-signal models using Lyapunov theories and linear matrix inequalities, and
wherein a convex optimization model is solved to allocate the centralized [symbol] _{∞} controller that stabilizes the microgrid over the uncertain convex polytope.

9. The control system of claim 1, wherein the multi-agent system includes a group of battery energy storage devices,
wherein the distributed control is a decentralized cooperative multi-agent control to synchronize the power and state of charge (SOCs) among the battery energy storage devices.

10. The control system of claim 9, wherein the multi-agent control operates according to a coordinated leader-follower multi-agent control strategy configured to
balance the state of charge (SOC) of the battery energy storage devices, by adjusting output power of operative batteries to balance the SOC while providing inertial support to the microgrid, while ensuring that no battery is depleted when available capacity exists in remaining battery energy storage devices.

11. A method of regulating frequency of an islanded microgrid, having at least one grid-tied renewable energy source, comprising:
generating, by a centralized [symbol] _{∞} controller, active and reactive power setpoints; and
controlling, by a distributed control, a multi-agent system, integrated into the grid through a grid-tied inverter coupled with an LCL filter, to adjust output power of a multi-agent microgrid storage cooperatively so that they achieve consensus in the energy while providing inertial support.

12. The method of claim 11, wherein the renewable energy source is a photovoltaic (PV) system.

13. The method of claim 11, wherein the renewable energy source is a wind turbine system.

14. The method of claim 11, further comprising:
regulating, by the centralized [symbol] _{∞} controller, the frequency of the islanded microgrid.

15. The method of claim 11, further comprising:
outputting, by the centralized [symbol] _{∞} controller, feedback that minimizes the maximum gain of the output over disturbances.

16. The method of claim 15, wherein the disturbances include power injections from the at least one grid-tied renewable energy source.

17. The method of claim 11, further comprising:
receiving, by a virtual inertial unit, the active and reactive power setpoints; and
enhancing the centralized [symbol] _{∞} controller to exhibit damping and inertia properties of a synchronous generator.

18. The method of claim 11, wherein microgrid dynamics are transformed into uncertain convex polytopic small-signal models using Lyapunov theories and linear matrix inequalities, the method further comprising:
solving a convex optimization model to allocate the centralized [symbol] _{∞} controller that stabilizes the microgrid over the uncertain convex polytope.

19. The method of claim 11, wherein the multi-agent system includes a group of battery energy storage devices,
the method further comprising:
synchronizing, by a decentralized cooperative multi-agent control, the power and state of charge (SOCs) among the battery energy storage devices.

20. The method of claim 19, further comprising:
balancing, by the multi-agent control operating according to a coordinated leader-follower multi-agent control strategy, the state of charge (SOC) of the battery energy storage devices, by adjusting output power of operative batteries to balance the SOC while providing inertial support to the microgrid, while ensuring that no battery is depleted when available capacity exists in remaining battery energy storage devices.
